(19) United States
(12) Patent Application Publication
(10) Pub. No.: US 2026/0362036 A1
(43) Pub. Date: Nov. 12, 2026

(54) IMAGING DEVICE, COMPARATOR, AND IMAGING METHOD

(71) Applicant: SONY SEMICONDUCTOR SOLUTIONS CORPORATION, KANAGAWA (JP)

(72) Inventor: KEISHI KUMATA, KANAGAWA (JP)

(21) Appl. No.: 19/515,505

(22) PCT Filed: Jul. 29, 2024
(86) PCT No.: PCT/JP2024/026937

§ 371 Date: Mar. 2, 2026

(30) Foreign Application Priority Data
Sep. 22, 2023 (JP) 2023-159099

(51) Int. Cl. H04N 25/78; H04N 25/77

(52) U.S. Cl. CPC H04N 25/78; H04N 25/77

(57) ABSTRACT

The present technology facilitates transfer of charge to a floating diffusion from a capacitor while suppressing a decrease in frame rate. An imaging device includes a pixel configured to transfer and hold charge obtained through photoelectric conversion, and an analog-to-digital (AD) conversion section configured to time-divisionally switch AD conversion of pixel signals read out from a plurality of the pixels in different rows of the same column. The pixel includes a photoelectric conversion section, a capacitor configured to hold charge obtained through photoelectric conversion by the photoelectric conversion section, a first transfer transistor configured to transfer, to the capacitor, the charge obtained through photoelectric conversion by the photoelectric conversion section, a second transfer transistor configured to transfer, to a floating diffusion, the charge held in the capacitor, an output transistor configured to output the pixel signal on the basis of the charge transferred to the floating diffusion, and a selection transistor configured to select an output of the pixel signal.

### TECHNICAL FIELD

The present technology relates to an imaging device, a comparator, and an imaging method. More specifically, the present technology relates to an imaging device, a comparator, and an imaging method that can transfer photoelectrically converted charge and hold the charge in a pixel.

### BACKGROUND ART

In a global shutter, a capacitor that holds charge transferred from a photoelectric conversion section is provided in a pixel. For example, an imaging device provided with a pixel including a capacitor that holds charge transferred from a photoelectric conversion section and a floating diffusion that receives transfer of the charge from the capacitor has been proposed (refer to PTL 1, for example).

### CITATION LIST

### Patent Literature

PTL 1: JP 2020-21987 A

### SUMMARY

### Technical Problem

However, in the prior art described above, during a period of transfer of the charge from the capacitor to the floating diffusion, analog-to-digital (AD) conversion of pixel signals is put on standby for each row, which may cause a decrease in frame rate.

The present technology has been made in view of such circumstances, and an object thereof is to facilitate transfer of charge to a floating diffusion from a capacitor while suppressing a decrease in frame rate.

### Solution to Problem

The present technology has been made to solve the problems described above, and a first aspect thereof is an imaging device including a pixel configured to transfer and hold charge obtained through photoelectric conversion, and an analog-to-digital (AD) conversion section configured to time-divisionally switch AD conversion of pixel signals read out from a plurality of the pixels in different rows of the same column. According to this configuration, an effect of AD-converting the pixel signals read out from a first pixel and a second pixel in the same column without providing a waiting period before AD conversion of the first pixel and the second pixel is achieved.

Further, in the first aspect, the pixel may include a photoelectric conversion section, a capacitor configured to hold charge obtained through photoelectric conversion by the photoelectric conversion section, a first transfer transistor configured to transfer, to the capacitor, the charge obtained through photoelectric conversion by the photoelectric conversion section, a second transfer transistor configured to transfer, to a floating diffusion, the charge held in the capacitor, an output transistor configured to output the pixel signal on the basis of the charge transferred to the floating diffusion, and a selection transistor configured to select an output of the pixel signal. According to this configuration, an effect of forming a pixel that can transfer and hold the charge obtained by photoelectric conversion is achieved.

Further, in the first aspect, the AD conversion section may be configured to implement, in an AD conversion period overlapping a transfer period of transferring the charge held in the capacitor of a first pixel of a first row in a first column to the floating diffusion, AD conversion of the pixel signal read out from a second pixel of a second row in the first column. According to this configuration, an effect of AD-converting the pixel signal read out from the second pixel in the same column as the first pixel during the transfer of the charge in the first pixel is achieved.

Further, the imaging device in the first aspect may include a vertical signal line configured to transmit the pixel signal in a column direction, a first comparator with an input connected to the vertical signal line, and a second comparator with an input connected to the vertical signal line. According to this configuration, an effect of time-divisionally AD-converting the pixel signals read out from the pixels in different rows of the same column by using the two comparators is achieved.

Further, in the first aspect, after an auto-zero operation of the first comparator, P-phase AD conversion of the pixel signal read out from the first pixel may be implemented by the first comparator; after the implementation of the P-phase AD conversion of the pixel signal read out from the first pixel, an auto-zero operation of the second comparator may be implemented; after the implementation of the auto-zero operation of the second comparator, P-phase AD conversion of the pixel signal read out from the second pixel may be implemented by the second comparator; after the implementation of the P-phase AD conversion of the pixel signal read out from the second pixel, D-phase AD conversion of the pixel signal read out from the first pixel may be implemented by the first comparator; and after the implementation of the D-phase AD conversion of the pixel signal read out from the first pixel, D-phase AD conversion of the pixel signal read out from the second pixel may be implemented by the second comparator. According to this configuration, an effect of implementing P-phase and D-phase AD conversion of the pixel signal read out from the first pixel after the auto-zero operation of the first comparator, and P-phase and D-phase AD conversion of the pixel signal read out from the second pixel after the auto-zero operation of the second comparator is achieved.

Further, in the first aspect, the AD conversion by the second comparator may be put on standby during the AD conversion by the first comparator, and the AD conversion by the first comparator may be put on standby during the AD conversion by the second comparator. According to this configuration, an effect of activating the comparators in accordance with a usage state of the comparators is achieved.

Further, the imaging device in the first aspect may include a vertical signal line configured to transmit the pixel signal in a column direction, a comparator with an input connected to the vertical signal line, a first switch connected between the input of the comparator and the vertical signal line, and a second switch connected between the input of the comparator and the vertical signal line. According to this configuration, an effect of time-divisionally AD-converting the pixel signals read out from the pixels in different rows of the same column on the basis of the switching operation of the input of a single comparator is achieved.

Further, in the first aspect, AD conversion of the pixel signal read out from the first pixel may be implemented when the first switch is on and the second switch is off, and AD conversion of the pixel signal read out from the second pixel may be implemented by the comparator when the first switch is off and the second switch is on. According to this configuration, an effect of implementing AD conversion of the pixel signal read out from the second pixel during transfer of the charge held in the first pixel and implementing AD conversion of the pixel signal read out from the first pixel during transfer of the charge held in the second pixel is achieved.

Further, the imaging device in the first aspect may include a vertical signal line configured to transmit the pixel signal in a column direction, and a comparator with a first input and a second input connected to the vertical signal line. The comparator may include a first transistor, a second transistor, a third transistor configured to form a differential pair with each of the first transistor and the second transistor, a fourth transistor configured to form a differential pair with each of the first transistor and the second transistor, a first switch connected in series to the first transistor, a second switch connected in series to the second transistor, a third switch connected in series to the third transistor, and a fourth switch connected in series to the fourth transistor. According to this configuration, an effect of time-divisionally AD-converting the pixel signals read out from the pixels in different rows of the same column while suppressing the influence of charge injection and feedthrough caused by the switching operation of the input of a single comparator is achieved.

Further, the imaging device in the first aspect may include a first capacitor connected in series to a gate of the first transistor, a second capacitor connected in series to a gate of the second transistor, a third capacitor connected in series to a gate of the third transistor, a fourth capacitor connected in series to a gate of the fourth transistor, a first auto-zero switch connected between the gate of the first transistor and the first switch, a second auto-zero switch connected between the gate of the second transistor and the second switch, a third auto-zero switch connected between the gate and a drain of the third transistor, and a fourth auto-zero switch connected between the gate and a drain of the fourth transistor. According to this configuration, an effect of achieving the auto-zero operation of the comparator while suppressing transmission of the influence of charge injection and feedthrough caused by the switching operation of the input of a single comparator to the capacitor is achieved.

Further, in the first aspect, when the first switch and the third switch are on and the second switch and the fourth switch are off, the first auto-zero switch and the third auto-zero switch may turn on to implement an auto-zero operation, and then P-phase AD conversion of the pixel signal read out from the first pixel may be implemented by the comparator; when the first switch and the third switch are off and the second switch and the fourth switch are on, the second auto-zero switch and the fourth auto-zero switch may turn on to implement an auto-zero operation, and then P-phase AD conversion of the pixel signal read out from the second pixel may be implemented by the comparator; when the first switch and the third switch are on and the second switch and the fourth switch are off, D-phase AD conversion of the pixel signal read out from the first pixel may be implemented by the comparator; and when the first switch and the third switch are off and the second switch and the fourth switch are on, D-phase AD conversion of the pixel signal read out from the second pixel may be implemented by the comparator. According to this configuration, an effect of time-divisionally AD-converting the pixel signals read out from the pixels in different rows of the same column on the basis of the switching operation of the input of a single comparator after the auto-zero operation is achieved.

Further, the imaging device in the first aspect may further include a first P-phase register configured to hold a P-phase AD conversion result of the pixel signal read out from the first pixel, a second P-phase register configured to hold a P-phase AD conversion result of the pixel signal read out from the second pixel, and a correlated double sampling (CDS) processing unit configured to implement first CDS processing on the basis of the P-phase AD conversion result of the pixel signal read out from the first pixel and held in the first P-phase register and a D-phase AD conversion result of the pixel signal read out from the first pixel and output from the AD conversion section, and second CDS processing on the basis of the P-phase AD conversion result of the pixel signal read out from the second pixel and held in the second P-phase register and a D-phase AD conversion result of the pixel signal read out from the second pixel and output from the AD conversion section. According to this configuration, an effect of achieving the CDS processing while time-divisionally AD-converting the pixel signals read out from the pixels in different rows of the same column in a charge domain global shutter system is achieved.

Further, in the first aspect, the pixel may be configured to transfer and hold the charge obtained by photoelectric conversion on the basis of a global shutter operation. According to this configuration, an effect of simultaneously starting exposure in all pixels is achieved.

Further, a second aspect is a comparator including a first transistor, a second transistor, a third transistor configured to form a differential pair with each of the first transistor and the second transistor, a fourth transistor configured to form a differential pair with each of the first transistor and the second transistor, a first switch connected in series to the first transistor, a second switch connected in series to the second transistor, a third switch connected in series to the third transistor, and a fourth switch connected in series to the fourth transistor. According to this configuration, an effect of time-divisionally AD-converting a plurality of signals while suppressing the influence of charge injection and feedthrough caused by the switching operation of the input of a single comparator is achieved.

Further, in the second aspect, a first capacitor may be connected in series to a gate of the first transistor, a second capacitor may be connected in series to a gate of the second transistor, a third capacitor may be connected in series to a gate of the third transistor, a fourth capacitor may be connected in series to a gate of the fourth transistor, a first auto-zero switch may be connected between the gate of the first transistor and the first switch, a second auto-zero switch may be connected between the gate of the second transistor and the second switch, a third auto-zero switch may be connected between the gate and a drain of the third transistor, and a fourth auto-zero switch may be connected between the gate and a drain of the fourth transistor. According to this configuration, an effect of suppressing transmission of the influence of charge injection and feedthrough caused by the switching operation of the input of a single comparator to the capacitor is achieved.

Further, in the second aspect, the second switch and the fourth switch may be turned off when the first switch and the third switch are turned on, and the second switch and the fourth switch may be turned on when the first switch and the third switch are turned off. According to this configuration, an effect of time-divisionally AD-converting the plurality of signals on the basis of the switching operation of the input of a single comparator is achieved.

Further, in the second aspect, the first auto-zero switch and the third auto-zero switch may be turned on when the first switch and the third switch are turned on, and the second auto-zero switch and the fourth auto-zero switch may be turned on when the second switch and the fourth switch are turned on. According to this configuration, an effect of time-divisionally AD-converting the plurality of signals on the basis of the switching operation of the input of a single comparator after the auto-zero operation is achieved.

Further, in the second aspect, a gate of the first transistor and a gate of the second transistor may be connected to the same signal line, and a gate of the third transistor and a gate of the fourth transistor may receive the same reference signal. According to this configuration, an effect of time-divisionally single-slope AD-converting the pixel signals read out from the pixels in different rows of the same column is achieved.

Further, a third aspect is an imaging method including transferring, by a first pixel of a first row in a first column, charge obtained through photoelectric conversion to, and holding the charge in, a capacitor in the first pixel, transferring, by a second pixel of a second row in the first column, charge obtained through photoelectric conversion to, and holding the charge in, a capacitor in the second pixel, and implementing, by an AD conversion section, AD conversion of a pixel signal read out from the second pixel in an AD conversion period overlapping a transfer period of transferring the charge held in the capacitor of the first pixel to a floating diffusion. According to this configuration, an effect of AD-converting the pixel signal read out from the second pixel in the same column as the first pixel during the transfer of the charge in the first pixel is achieved.

### BRIEF DESCRIPTION OF DRAWINGS

FIG. 1 is a block diagram depicting a configuration example of an imaging device according to a first embodiment.

FIG. 2 is a block diagram depicting a configuration example of a solid-state imaging device according to the first embodiment.

FIG. 3 is a diagram depicting a circuit configuration example of pixels of the solid-state imaging device according to the first embodiment.

FIG. 4 is a block diagram depicting a schematic configuration example of an AD conversion section of the solid-state imaging device according to the first embodiment.

FIG. 5 depicts timing charts depicting waveforms of respective sections of a pixel during operation of the solid-state imaging device according to the first embodiment.

FIG. 6 is a timing chart depicting waveforms of respective sections of pixels and a vertical signal line during AD conversion of the solid-state imaging device according to the first embodiment.

FIG. 7 is a block diagram depicting a configuration example of an AD conversion section of one column of the solid-state imaging device according to the first embodiment.

FIG. 8 is a timing chart depicting an operation example of the AD conversion section of one column of the solid-state imaging device according to the first embodiment.

FIG. 9 is a block diagram depicting a configuration example of a column signal processing unit of the solid-state imaging device according to the first embodiment.

FIG. 10 is a timing chart depicting operation of CDS processing of the solid-state imaging device according to the first embodiment.

FIG. 11 is a block diagram depicting a configuration example of the AD conversion section of one column of the solid-state imaging device according to a second embodiment.

FIG. 12 is a timing chart depicting an operation example of the AD conversion section of one column of the solid-state imaging device according to the second embodiment.

FIG. 13 is a block diagram depicting a configuration example of the AD conversion section of one column of the solid-state imaging device according to a third embodiment.

FIG. 14 is a timing chart depicting an operation example of the AD conversion section of one column of the solid-state imaging device according to the third embodiment.

FIG. 15 is a block diagram depicting a configuration example of the AD conversion section of one column of the solid-state imaging device according to a fourth embodiment.

FIG. 16 is a diagram depicting a configuration example of a comparator of one column of the solid-state imaging device according to the fourth embodiment.

FIG. 17 is a diagram depicting a configuration example of the comparator of one column of the solid-state imaging device according to a fifth embodiment.

FIG. 18 is a diagram depicting a circuit configuration example of the pixels of the solid-state imaging device according to a sixth embodiment.

FIG. 19 is a diagram depicting a readout order of the pixels of the solid-state imaging device according to the sixth embodiment.

FIG. 20 is a timing chart depicting operation of the solid-state imaging device according to the sixth embodiment.
FIG. 21 is a timing chart depicting operation of the solid-state imaging device according to a seventh embodiment.

FIG. 22 is a timing chart depicting operation of the solid-state imaging device according to an eighth embodiment.

FIG. 23 is a timing chart depicting operation of the solid-state imaging device according to a ninth embodiment.

FIG. 24 is a timing chart depicting operation of the solid-state imaging device according to a tenth embodiment.

FIG. 25 is a diagram depicting a readout order of the pixels of the solid-state imaging device according to an eleventh embodiment.

FIG. 26 is a timing chart depicting operation of the solid-state imaging device according to the eleventh embodiment.

FIG. 27 is a timing chart depicting an operation example of the AD conversion section of one column of the solid-state imaging device according to the eleventh embodiment.

FIG. 28 is a timing chart depicting operation of the CDS processing of the solid-state imaging device according to the eleventh embodiment.

FIG. 29 is a perspective view depicting a layering example of a pixel array section according to a twelfth embodiment.

FIG. 30 is a block diagram depicting a schematic configuration example of a vehicle control system.

FIG. 31 is an explanatory view depicting an example of an installation position of an imaging section.

### DESCRIPTION OF EMBODIMENTS

Hereinafter, modes (hereinafter, referred to as embodiments) for implementing the present technology will be described. The description will be made in the following order.
1. First Embodiment (example in which pixel signals read out from pixels in different rows of the same column are time-divisionally AD-converted on the basis of switching operation of two comparators)
2. Second Embodiment (example in which pixel signals read out from pixels in different rows of the same column are time-divisionally AD-converted on the basis of switching operation of two comparators, and unused comparator is put on standby)
3. Third Embodiment (example in which pixel signals read out from pixels in different rows of the same column are time-divisionally AD-converted on the basis of switching operation of input of single comparator)
4. Fourth Embodiment (example in which switch for time-divisionally AD-converting pixel signals read out from pixels in different rows of the same column on the basis of switching operation of input of single comparator and for switching input is built into comparator)
5. Fifth Embodiment (example in which pixel signals read out from pixels in different rows of the same column are time-divisionally AD-converted on the basis of switching operation of input of single comparator, switch for switching input is built into comparator, and auto-zero operation on input side of reference signal is omitted)
6. Sixth Embodiment (example in which charge domain is applied to each pixel of four-pixel shared cell)
7. Seventh Embodiment (example in which reset period of four-pixel shared cell to which charge domain is applied is made to differ from transfer period of charge held in capacitor)
8. Eighth Embodiment (example in which reset period of two-pixel shared cell to which charge domain is applied is made to differ from transfer period of charge held in capacitor)
9. Ninth Embodiment (example in which reset period of four-pixel shared cell to which charge domain is applied is made to differ from transfer period of charge held in capacitor and to overlap D-phase AD conversion period)
10. Tenth Embodiment (example in which reset period of two-pixel shared cell to which charge domain is applied is made to differ from transfer period of charge held in capacitor and overlap D-phase AD conversion period)
11. Eleventh Embodiment (example in which it is possible to switch processing of putting AD conversion on standby during transfer period of charge held in capacitor in charge domain and processing of executing AD conversion in an overlapping manner with transfer period of charge held in capacitor in charge domain)
12. Twelfth Embodiment (example in which semiconductor chips forming a solid-state imaging device are layered)
13. Example of Application to Mobile Body

### 1. First Embodiment

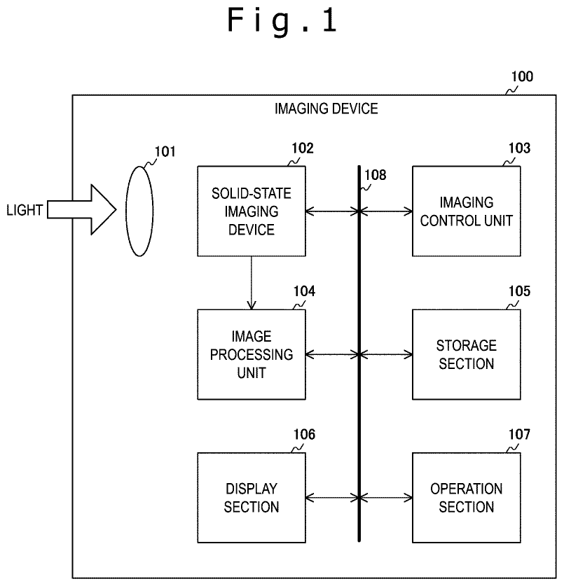

FIG. 1 is a block diagram depicting a configuration example of an imaging device according to a first embodiment.

In FIG. 1, an imaging device 100 includes an optical system 101, a solid-state imaging device 102, an imaging control unit 103, an image processing unit 104, a storage section 105, a display section 106, and an operation section 107. The imaging control unit 103, the image processing unit 104, the storage section 105, the display section 106, and the operation section 107 are connected to each other via a bus 108. Note that the imaging device 100 may be used as a single body, may be incorporated into a mobile terminal such as a smartphone, may be incorporated into an authentication device or a monitoring device, or may be incorporated into a vehicle or a drone.

The optical system 101 causes light from a subject to be incident on the solid-state imaging device 102, and forms an optical image on a light-receiving surface of the solid-state imaging device 102. The optical system 101 may include, for example, a focusing lens, a zoom lens, and a diaphragm. The optical system 101 may include a plurality of lenses such as a wide-angle lens, a standard lens, and a telephoto lens.

The solid-state imaging device 102 converts the optical image formed on the light-receiving surface into an electric signal for each pixel, digitizes the electric signal, and outputs the digitized electric signal. At this time, the solid-state imaging device 102 can operate on the basis of a charge domain global shutter system. The solid-state imaging device 102 is a complementary metal oxide semiconductor (CMOS) image sensor, for example. The CMOS image sensor may be a back-illuminated image sensor or may be a front-illuminated image sensor. Further, the light received by the solid-state imaging device 102 may be visible light, may be near infrared (NIR) light, may be short wavelength infrared (SWIR) light, and may be ultraviolet light, X-rays, or the like.

The imaging control unit 103 controls imaging by the solid-state imaging device 102 on the basis of a command from the operation section 107. At this time, the imaging control unit 103 can control an exposure time, an exposure amount, an imaging timing, and the like of the solid-state imaging device 102.

The image processing unit 104 implements image processing on the basis of an output from the solid-state imaging device 102. The image processing includes, for example, gamma correction, white balance processing, sharpness processing, and gradation conversion processing. The image processing unit 104 may include a processor that executes processing on the basis of software.

The storage section 105 stores an imaged image imaged by the solid-state imaging device 102, and stores imaging parameters and the like of the solid-state imaging device 102. In addition, the storage section 105 can store a program for operating the imaging device 100 on the basis of software. The storage section 105 may include a read only memory (ROM), a random access memory (RAM), and a memory card.

The display section 106 displays an imaged image and various types of information for supporting an imaging operation. The display section 106 may be a liquid crystal display or may be an organic electro-luminescence (EL) display.

The operation section 107 provides a user interface for operating the imaging device 100. The operation section 107 may include, for example, a button, a dial, and a switch provided in the imaging device 100. The operation section 107 may be constituted by a touch panel together with the display section 106.

Note that, depending on the form of the imaging device 100, some of the functions described above may be omitted or, conversely, functions not disclosed may be further included.

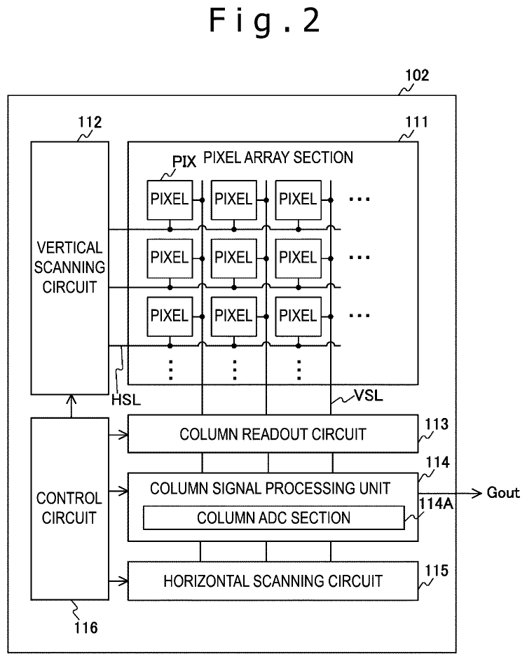

FIG. 2 is a block diagram depicting a configuration example of the solid-state imaging device according to the first embodiment.

In the drawing, the solid-state imaging device 102 includes a pixel array section 111, a vertical scanning circuit 112, a column readout circuit 113, a column signal processing unit 114, a horizontal scanning circuit 115, and a control circuit 116.

The pixel array section 111 includes a plurality of pixels PIX. The pixels PIX are arrayed in a matrix in a row direction (also referred to as horizontal direction) and a column direction (also referred to as vertical direction). Each pixel PIX can transfer and hold photoelectrically converted charge on the basis of a global shutter operation. Each pixel PIX can form a source follower per column with the column readout circuit 113 during signal readout. Each pixel PIX is connected to a horizontal drive line HSL on a per row basis and is connected to a vertical signal line VSL on a per column basis. The horizontal drive line HSL drives each pixel PIX on a per row basis during signal readout from each pixel PIX. The vertical signal line VSL transmits a potential on the basis of a current flowing during signal readout from the pixels PIX to the column signal processing unit 114 on a per column basis.

The vertical scanning circuit 112 scans, in the column direction, the pixels PIX to be read out. The vertical scanning circuit 112 may be configured by using a vertical register.

The column readout circuit 113 can form a source follower on a per column basis with each pixel PIX via the vertical signal line VSL during signal readout from each pixel PIX. At this time, the column readout circuit 113 can change a potential of the vertical signal line VSL on the basis of charge held in the pixel PIX.

The column signal processing unit 114 processes signals transmitted from each pixel PIX in the column direction. For example, the column signal processing unit 114 can implement correlated double sampling (CDS) processing on the basis of the signals transmitted from each pixel PIX in the column direction. The column signal processing unit 114 can implement analog-to-digital (AD) conversion processing on the basis of the signals transmitted from each pixel PIX in the column direction and output an imaging signal Gout.

The column signal processing unit 114 includes a column ADC section 114A. The column ADC section 114A can implement AD conversion processing in parallel for each column. At this time, the column ADC section 114A can AD-convert each column on the basis of a comparison result between the pixel signal read out from the pixel PIX and a reference signal. Here, the column ADC section 114A can time-divisionally switch AD conversion of the pixel signals read out from pixels in different rows of the same column. Note that the column ADC section 114A is an example of the AD conversion section described in the appended claims.

The horizontal scanning circuit 115 scans, in the row direction, the pixels PIX to be read. The horizontal scanning circuit 115 may be configured by using a horizontal register.

The control circuit 116 controls the vertical scanning circuit 112, the column readout circuit 113, the column signal processing unit 114, and the horizontal scanning circuit 115. For example, the control circuit 116 can control a scanning timing in the column direction, a scanning timing in the row direction, an operation timing of the column readout circuit 113, and a processing timing of the column signal processing unit 114.

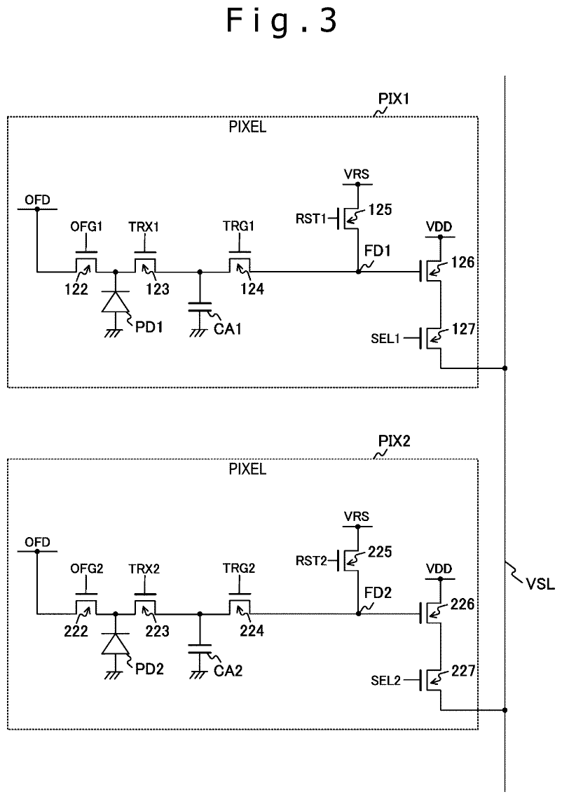

FIG. 3 is a diagram depicting a circuit configuration example of the pixels of the solid-state imaging device according to the first embodiment. Note that, in the drawing, a configuration for two pixels in different rows of the same column is depicted.

In the drawing, pixels PIX1 and PIX2 include photodiodes PD1 and PD2, floating diffusions FD1 and FD2, capacitors CA1 and CA2, and overflow control transistors 122 and 222. Furthermore, the pixels PIX1 and PIX2 include transfer transistors 123, 124, 223, and 224, reset transistors 125 and 225, output transistors 126 and 226, and selection transistors 127 and 227.

The overflow control transistors 122 and 222, the transfer transistors 123, 124, 223, and 224, the reset transistors 125 and 225, the output transistors 126 and 226, and the selection transistors 127 and 227 may be metal oxide semiconductor (MOS) transistors. The capacitors CA1 and CA2 may be metal-insulation-metal (MIM) capacitors or may be junction capacitors formed in a semiconductor substrate.

The photodiodes PD1 and PD2 implement photoelectric conversion and accumulate photoelectrically converted charge. Note that the photodiodes PD1 and PD2 are examples of the photoelectric conversion section described in the appended claims. The capacitors CA1 and CA2 hold the charge transferred from the photodiodes PD1 and PD2. The transfer of the charge from the photodiodes PD1 and PD2 to the capacitors CA1 and CA2 may be implemented simultaneously for all pixels. The overflow control transistors 122 and 222 control overflow of the charge from the photodiodes PD1 and PD2.

The transfer transistors 123 and 223 transfer the charge accumulated in the photodiodes PD1 and PD2 to the capacitors CA1 and CA2. The transfer transistors 124 and 224 transfer the charge held in the capacitors CA1 and CA2 to the floating diffusions FD1 and FD2. The reset transistors 125 and 225 reset the floating diffusions FD1 and FD2. The output transistors 126 and 226 output signals corresponding to the potentials of the floating diffusions FD1 and FD2. The selection transistors 127 and 227 select the outputs of the output transistors 126 and 226.

In the pixel PIX1, the output transistor 126 and the selection transistor 127 are connected in series. A cathode of the photodiode PD1 is connected to an overflow potential OFD via the overflow control transistor 122. Further, the cathode of the photodiode PD1 is connected to the capacitor CA1 via the transfer transistor 123. Further, the capacitor CA1 is connected to the floating diffusion FD1 via the transfer transistor 124. Further, the floating diffusion FD1 is connected to a reset voltage VRS via the reset transistor 125. A series circuit of the output transistor 126 and the selection transistor 127 is connected between a power supply voltage VDD and the vertical signal line VSL. A gate of the output transistor 126 is connected to the floating diffusion FD1.

In the pixel PIX2, the output transistor 226 and the selection transistor 227 are connected in series. A cathode of the photodiode PD2 is connected to the overflow potential OFD via the overflow control transistor 222. Further, the cathode of the photodiode PD2 is connected to the capacitor CA2 via the transfer transistor 223. Further, the capacitor CA2 is connected to the floating diffusion FD2 via the transfer transistor 224. Further, the floating diffusion FD2 is connected to the reset voltage VRS via the reset transistor 225. A series circuit of the output transistor 226 and the selection transistor 227 is connected between the power supply voltage VDD and the vertical signal line VSL. A gate of the output transistor 226 is connected to the floating diffusion FD2.

Overflow control signals OFG1 and OFG2 are applied to gates of the overflow control transistors 122 and 222. Transfer signals TRX1 and TRX2 are applied to gates of the transfer transistors 123 and 223. Transfer signals TRG1 and TRG2 are applied to gates of the transfer transistors 124 and 224. Reset signals RST1 and RST2 are applied to gates of the reset transistors 125 and 225. Selection signals SEL1 and SEL2 are applied to gates of the selection transistors 127 and 227. The overflow control signals OFG1 and OFG2, the transfer signals TRX1, TRX2, TRG1, and TRG2, the reset signals RST1 and RST2, and the selection signals SEL1 and SEL2 can be transmitted to the pixels PIX1 and PIX2 via the horizontal drive lines HSL in FIG. 2.

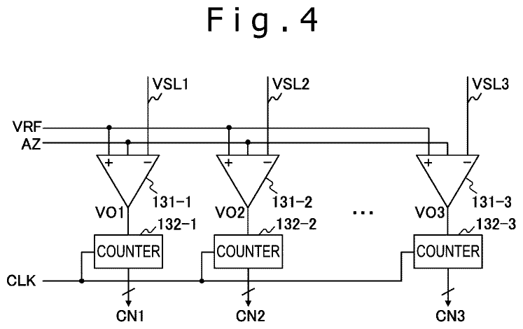

FIG. 4 is a block diagram depicting a schematic configuration example of the AD conversion section of the solid-state imaging device according to the first embodiment.

In the drawing, the column ADC section 114A in FIG. 2 includes comparison sections 131-1 to 131-3 and counters 132-1 to 132-3 for each column. Vertical signal lines VSL1 to VSL3 are provided for each column. The comparison sections 131-1 to 131-3 compare the pixel signals transmitted via the vertical signal lines VSL1 to VSL3 with a reference signal VRF, and output comparison results VO1 to VO3 to the counters 132-1 to 132-3. The reference signal VRF may include a ramp signal. Here, each of the comparison sections 131-1 to 131-3 can time-divisionally switch AD conversion of the pixel signals read out from pixels in different rows of the same column. At this time, each of the comparison sections 131-1 to 131-3 may include, for each column, one or more comparators that time-divisionally switch and input the pixel signals read out from pixels in different rows of the same column.

Further, an auto-zero signal AZ is input to each of the comparison sections 131-1 to 131-3. The auto-zero signal AZ activates auto-zero operation during an auto-zero period. In the auto-zero operation, charge for balancing a non-inverting input and an inverting input of each of the comparison sections 131-1 to 131-3 can be accumulated in a DC cut capacitor.

A clock signal CKL is input to each of the counters 132-1 to 132-3. At this time, the counters 132-1 to 132-3 each implement a counting operation on the basis of an output timing of the comparison results VO1 to VO3 output from the comparison sections 131-1 to 131-3. Then, the counters 132-1 to 132-3 digitize the pixel signals transmitted via the vertical signal lines VSL1 to VSL3 on the basis of count values CN1 to CN3 based on the counting operations.

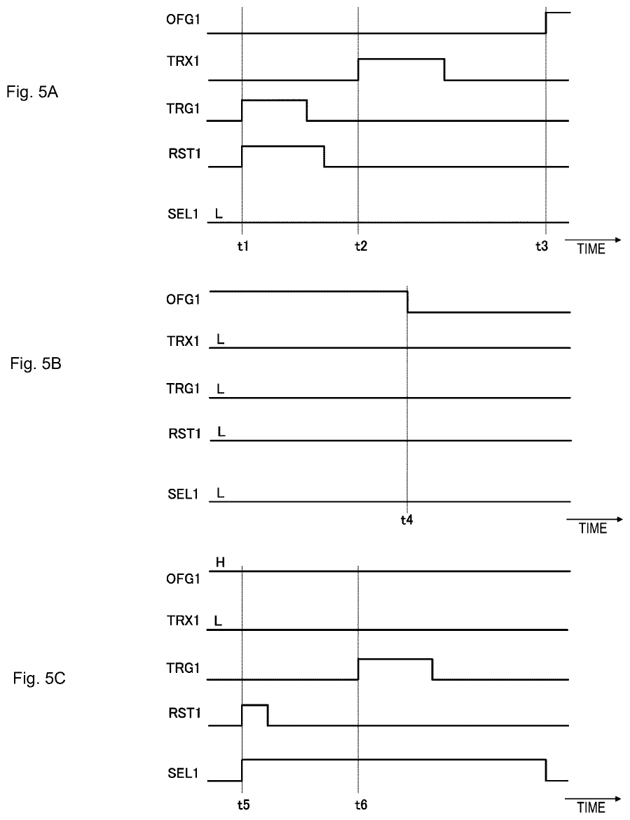

FIG. 5 depicts timing charts depicting waveforms of respective sections of a pixel during operation of the solid-state imaging device according to the first embodiment. Note that, in the drawing, the operation of the pixel PIX1 in FIG. 3 is used as an example. Further, a in the drawing depicts a waveform during transmission of the charge from the photodiode PD1 to the capacitor CA1. b in the drawing depicts a waveform during a shutter operation of the pixel PIX1. c in the drawing depicts a waveform during readout of the pixel signal from the pixel PIX1.

In a in the drawing, during transmission of the charge from the photodiode PD1 to the capacitor CA1, the selection signal SEL1 is set to a low level, and the selection transistor 127 is turned off. Then, the transfer signal TRG1 and the reset signal RST1 rise (t1), and the transfer transistor 124 and the reset transistor 125 are turned on, thereby resetting the capacitor CA1 and the floating diffusion FD1.

Next, the transfer signal TRG1 and the reset signal RST1 sequentially fall, and subsequently the transfer signal TRX1 rises (t2). At this time, the transfer transistor 123 turns on in a state in which the transfer transistor 124 and the reset transistor 125 are turned off, thereby transferring the charge accumulated in the photodiode PD1 to the capacitor CA1. Then, the transfer signal TRX1 falls, and subsequently the overflow control signal OFG1 rises (t3).

In b in the drawing, the transfer signals TRX1 and TRG1, the reset signal RST1, and the selection signal SEL1 are set to a low level during a shutter operation. Then, the overflow control signal OFG1 falls (t4), and the overflow control transistor 122 turns off. This shutter operation can be implemented simultaneously for all pixels including the pixel PIX1, and exposure can be started simultaneously for all pixels.

In c in the drawing, in the readout of the pixel signal, the overflow control signal OFG1 is set to a high level, the transfer signal TRX1 is set to a low level, the overflow control transistor 122 is turned on, and the selection transistor 127 is turned off. Then, the reset signal RST1 and the selection signal SEL1 rise (t5), and the reset transistor 125 and the selection transistor 127 are turned on. At this time, the floating diffusion FD1 is reset, and the P-phase level of the floating diffusion FD1 is transmitted through the vertical signal line VSL.

Next, the reset signal RST1 falls, the transfer signal TRG1 rises in a state in which the reset transistor 125 is turned off, and the transfer transistor 124 is turned on (t6). At this time, the charge held in the capacitor CA1 is transferred to the floating diffusion FD1, and the D-phase level of the floating diffusion FD1 is transmitted through the vertical signal line VSL.

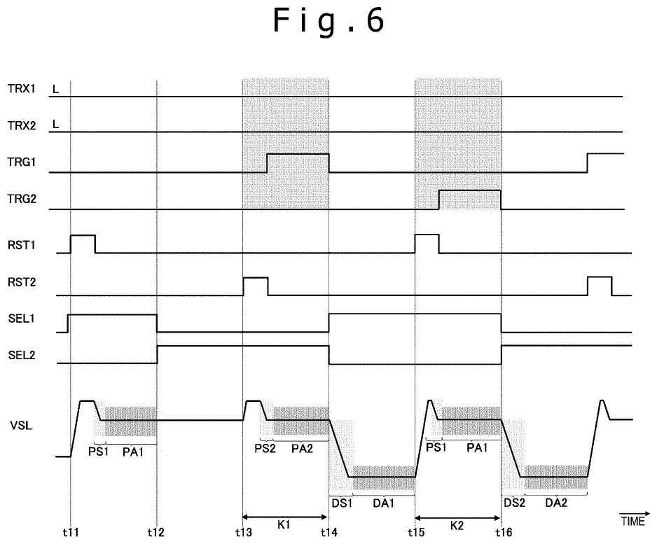

FIG. 6 is a timing chart depicting waveforms of respective sections of the pixels and the vertical signal line during AD conversion of the solid-state imaging device according to the first embodiment. Note that, in the drawing, the waveforms of the respective sections of the pixels PIX1 and PIX2 in FIG. 3 and the waveform of the vertical signal line VSL during AD conversion are depicted.

In the drawing, in this solid-state imaging device, a P-phase settling period PS2 and a P-phase AD conversion period PA2 of the pixel PIX2 are set so as to overlap a transfer period K1 of the charge from the capacitor CAI to the floating diffusion FD1 of the pixel PIX1. Further, a P-phase settling period PS1 and a P-phase AD conversion period PA1 of the pixel PIX1 are set so as to overlap a transfer period K2 of the charge from the capacitor CA2 to the floating diffusion FD2 of the pixel PIX2.

Specifically, the transfer signals TRX1 and TRX2 are always set to a low level. Then, the selection signal SEL1 rises, and subsequently the reset signal RST1 rises (t11) and the potential of the vertical signal line VSL is set in accordance with the P-phase level of the floating diffusion FD1. Then, the reset signal RST1 falls, the P-phase settling of the pixel PIX1 is implemented (PS1), and subsequently the P-phase AD conversion is implemented (PA1).

Next, the selection signal SEL1 falls and the selection signal SEL2 rises (t12).

Next, the reset signal RST2 rises (t13), and the potential of the vertical signal line VSL is set in accordance with the P-phase level of the floating diffusion FD2. Then, the reset signal RST2 falls, the P-phase settling of the pixel PIX2 is implemented (PS2), and subsequently the P-phase AD conversion is implemented (PA2).

Further, the transfer signal TRG1 rises at a falling edge timing of the reset signal RST2, the charge accumulated in the photodiode PD1 is transferred to the capacitor CA1, and subsequently the transfer signal TRG1 falls.

Next, the selection signal SEL1 rises and the selection signal SEL2 falls (t14), and the potential of the vertical signal line VSL is set in accordance with the D-phase level of the floating diffusion FD1. Then, the D-phase settling of the pixel PIX1 is implemented (DS1), and subsequently the D-phase AD conversion is implemented (DA1).

Next, the reset signal RST1 rises (t15), and the potential of the vertical signal line VSL is set in accordance with the P-phase level of the floating diffusion FD1. Then, the reset signal RST1 falls, the P-phase settling of the pixel PIX1 is implemented (PS1), and subsequently the P-phase AD conversion is implemented (PA1).

Further, the transfer signal TRG2 rises at a falling edge timing of the reset signal RST1, the charge accumulated in the photodiode PD2 is transferred to the capacitor CA2, and subsequently the transfer signal TRG2 falls.

Next, the selection signal SEL1 falls and the selection signal SEL2 rises (t16), and the potential of the vertical signal line VSL is set in accordance with the D-phase level of the floating diffusion FD2. Then, the D-phase settling of the pixel PIX2 is implemented (DS2), and subsequently the D-phase AD conversion is implemented (DA2).

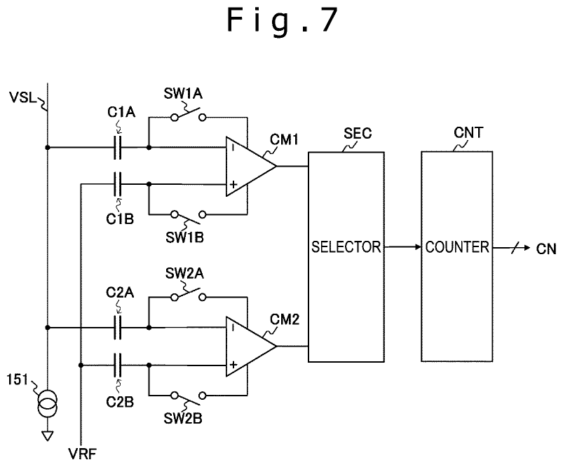

FIG. 7 is a block diagram depicting a configuration example of the AD conversion section of one column of the solid-state imaging device according to the first embodiment.

In the drawing, the column ADC section 114A includes comparators CM1 and CM2, a selector SEC, and a counter CNT. Inverting input terminals of the comparators CM1 and CM2 are connected to the vertical signal line VSL via capacitors C1A and C2A, respectively. The reference signal VRF is input to non-inverting input terminals of the comparators CM1 and CM2 via capacitors C1B and C2B, respectively. An auto-zero switch SW1A is connected between a gate and a drain of a differential transistor on the inverting input side of the comparator CM1. An auto-zero switch SW1B is connected between a gate and a drain of a differential transistor on the non-inverting input side of the comparator CM1. An auto-zero switch SW2A is connected between a gate and a drain of a differential transistor on the inverting input side of the comparator CM2. An auto-zero switch SW2B is connected between a gate and a drain of a differential transistor on the non-inverting input side of the comparator CM2. Outputs of the comparators CM1 and CM2 are input to the counter CNT. The vertical signal line VSL is grounded via a current source 151.

The selector SEC switches the outputs of the comparators CM1 and CM2 and inputs the outputs to the counter CNT. The counter CNT implements a counting operation on the basis of the output timing of the comparison results output from the comparators CM1 and CM2. At this time, the counter CNT digitizes the pixel signal transmitted via the vertical signal line VSL on the basis of a count value CN based on the counting operation.

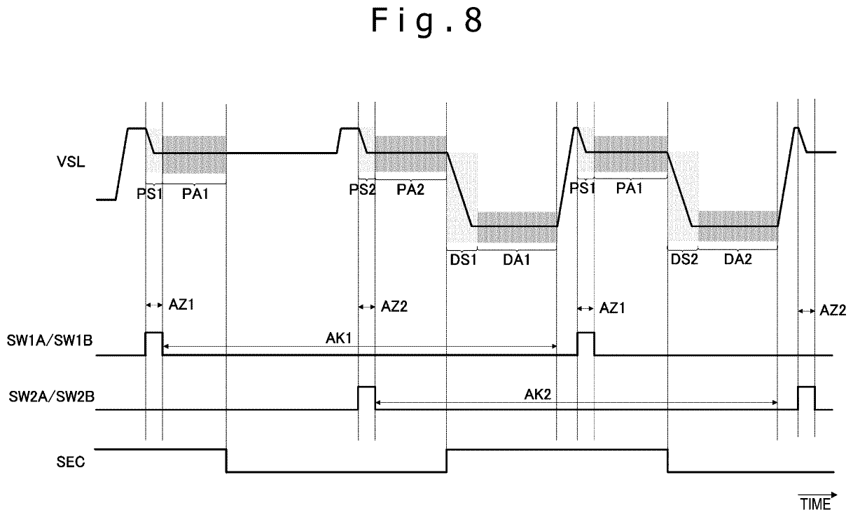

FIG. 8 is a timing chart depicting an operation example of the AD conversion section of one column of the solid-state imaging device according to the first embodiment.

In the drawing, the selector SEC switches the outputs of the comparators CM1 and CM2 in accordance with the readout timing of the pixels PIX1 and PIX2. Here, the auto-zero switches SW1A and SW1B are turned on while the comparator CM1 is selected, setting an auto-zero period AZ1 of the comparator CM1. At this time, the P-phase settling period PS1 is set during the auto-zero period AZ1. The auto-zero switches SW2A and SW2B are turned on during selection of the comparator CM2, setting an auto-zero period AZ2 of the comparator CM2. At this time, the P-phase settling period PS2 is set during the auto-zero period AZ2.

The current P-phase AD conversion period PA1 and the D-phase AD conversion period DAI are set between the current auto-zero period AZ1 and the next auto-zero period AZ1. The comparator CM1 is in use during a period AK1 from the current P-phase AD conversion period PAI to the D-phase AD conversion period DA1. The current P-phase AD conversion period PA2 and the D-phase AD conversion period DA2 are set between the current auto-zero period AZ2 and the next auto-zero period AZ2. The comparator CM2 is in use during a period AK2 from the current P-phase AD conversion period PA2 to the D-phase AD conversion period DA2. Therefore, the period in which the comparator CM1 is in use may overlap the period in which the comparator CM2 is in use.

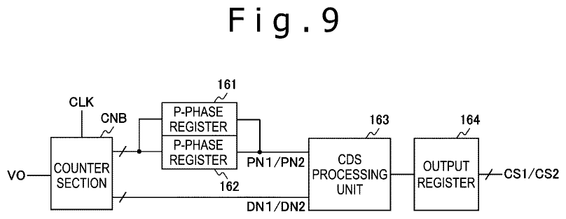

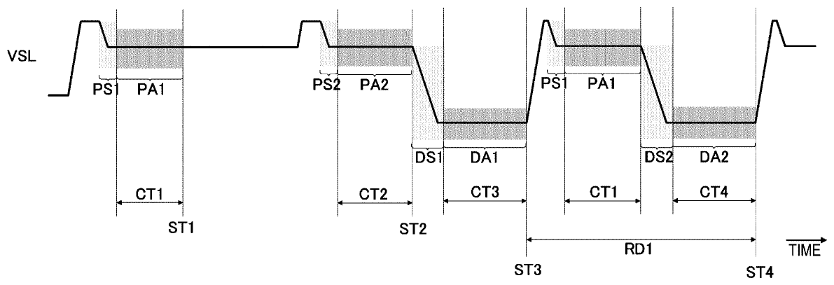

FIG. 9 is a block diagram depicting a configuration example of the column signal processing unit of the solid-state imaging device according to the first embodiment.

In the drawing, the column signal processing unit 114 in FIG. 2 includes a counter section CNB, P-phase registers 161 and 162, a CDS processing unit 163, and an output register 164.

The counter section CNB includes the counter CNT of FIG. 7 for each column. A comparison result VO of the comparators CM1 and CM2 is input to the counter section CNB for each column.

The P-phase register 161 stores a P-phase AD conversion result PN1 of the pixel PIX1. The P-phase register 162 stores a P-phase AD conversion result PN2 of the pixel PIX2. The P-phase registers 161 and 162 may be line memories.

The CDS processing unit 163 reads out the P-phase AD conversion result PN1 of the pixel PIX1 from the P-phase register 161 on the basis of the output timing of a D-phase AD conversion result DN1 of the pixel PIX1 from the counter section CNB. Then, the CDS processing unit 163 implements the CDS processing on the basis of the P-phase AD conversion result PN1 and the D-phase AD conversion result DN1. Further, the CDS processing unit 163 reads out the P-phase AD conversion result PN2 of the pixel PIX2 from the P-phase register 162 on the basis of the output timing of a D-phase AD conversion result DN2 of the pixel PIX2 from the counter section CNB. Then, the CDS processing unit 163 implements the CDS processing on the basis of the P-phase AD conversion result PN2 and the D-phase AD conversion result DN2.

The output register 164 stores CDS processing results CS1 and CS2 of the pixels PIX1 and PIX2 calculated by the CDS processing unit 163, and outputs the results at a predetermined timing.

FIG. 10 is a timing chart depicting operation of the CDS processing of the solid-state imaging device according to the first embodiment.

In the drawing, a P-phase count period CT1 is provided in the P-phase AD conversion period PA1 of the pixel PIX1. A P-phase count period CT2 is provided in the P-phase AD conversion period PA2 of the pixel PIX2. A D-phase count period CT3 is provided in the D-phase AD conversion period DA1 of the pixel PIX1. A D-phase count period CT4 is provided in the D-phase AD conversion period DA2 of the pixel PIX2.

After the P-phase count period CT1 of the pixel PIX1 is completed, the P-phase AD conversion result PN1 is stored in the P-phase register 161 (ST1). After the P-phase count period CT2 of the pixel PIX2 is completed, the P-phase AD conversion result PN2 is stored in the P-phase register 162 (ST2).

After the D-phase count period CT3 of the pixel PIX1 is completed, the CDS calculation is implemented, and the CDS processing result CS1 is stored in the output register 164 (ST3). After the D-phase count period CT4 of the pixel PIX2 is completed, the CDS calculation is implemented, and the CDS processing result CS2 is stored in the output register 164 (ST4). At this time, a readout period RD1 of the CDS processing result CS1 of the pixel PIX1 is set between a storage timing ST3 of the CDS processing result CS1 and a storage timing ST4 of the CDS processing result CS2.

Thus, in the first embodiment described above, the pixel signals read out from the pixels in different rows of the same column are time-divisionally AD-converted on the basis of the switching operation of the two comparators CM1 and CM2. This makes it possible to AD-convert the pixel signals read out from the pixels PIX1 and PIX2 in the same column without providing a waiting period before the AD conversion of the pixels PIX1 and PIX2. This makes it possible to improve, in the charge domain global shutter system, the frame rate without changing the configuration of the pixels PIX1 and PIX2.

### 2. Second Embodiment

In the first embodiment described above, the pixel signals read out from the pixels in different rows of the same column are time-divisionally AD-converted on the basis of the switching operation of the two comparators CM1 and CM2. In this second embodiment, the pixel signals read out from the pixels in different rows of the same column are time-divisionally AD-converted on the basis of the switching operation of two comparators, and the unused comparator is put on standby.

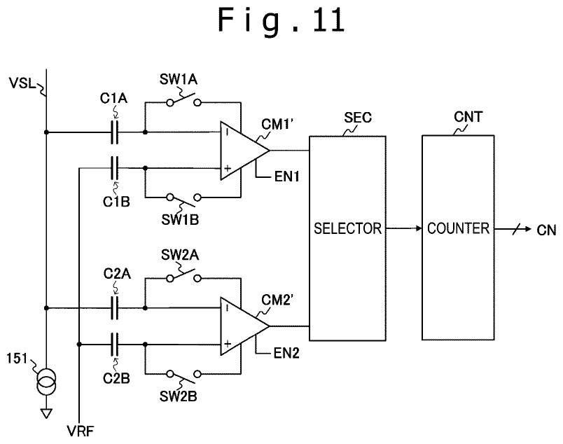

FIG. 11 is a block diagram depicting a configuration example of the AD conversion section of one column of the solid-state imaging device according to the second embodiment.

In the drawing, this solid-state imaging device includes comparators CM1′ and CM2′ instead of the comparators CM1 and CM2 of the first embodiment described above. Other configurations of the solid-state imaging device of the second embodiment are similar to the configurations of the solid-state imaging device of the first embodiment described above.

Enable signals EN1 and EN2 are input to the comparators CM1′ and CM2′. The comparators CM1′ and CM2′ are activated on the basis of the enable signals EN1 and EN2. Other configurations of the comparators CM1′ and CM2′ of the second embodiment are similar to the configurations of the comparators CM1 and CM2 of the first embodiment described above.

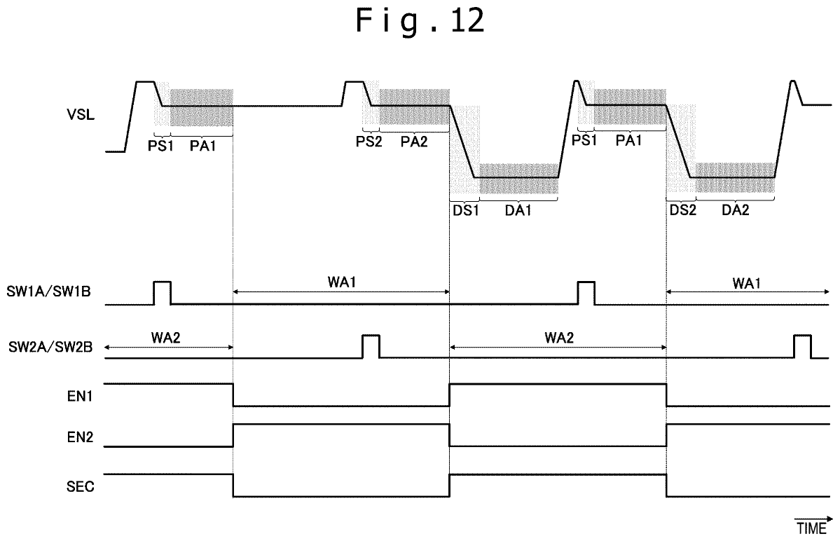

FIG. 12 is a timing chart depicting an operation example of the AD conversion section of one column of the solid-state imaging device according to the second embodiment.

In the drawing, in the P-phase settling period PS1 and the P-phase AD conversion period PA1 of the pixel PIX1, the enable signal EN1 is set to a high level, and the enable signal EN2 is set to a low level. When the enable signal EN1 is at a high level, the comparator CM1′ is selected by the selector SEC. At this time, the comparator CM1′ is activated to enable AD conversion, and the comparator CM2′ is deactivated and transitions to a waiting period WA2.

On the other hand, in the P-phase settling period PS2 and the P-phase AD conversion period PA2 of the pixel PIX2, the enable signal EN1 is set to a low level, and the enable signal EN2 is set to a high level. When the enable signal EN2 is at a high level, the comparator CM2′ is selected by the selector SEC. At this time, the comparator CM1′ is deactivated and transitions to a waiting period WA1, and the comparator CM2′ is activated to enable AD conversion.

Thus, in the second embodiment described above, the pixel signals read out from the pixels in different rows of the same column are time-divisionally AD-converted on the basis of the switching operation of the two comparators CM1′ and CM2′, and the unused comparator CM1′ or CM2′ is put on standby. This makes it possible to eliminate the need for overlapping use of the comparators CM1′ and CM2′. Thus, it is possible to reduce power consumption of the comparators CM1′ and CM2′ while time-divisionally AD-converting the pixel signals read out from the pixels in different rows of the same column on the basis of the switching operation of the two comparators CM1′ and CM2′.

### 3. Third Embodiment

In the first embodiment described above, the pixel signals read out from the pixels in different rows of the same column are time-divisionally AD-converted on the basis of the switching operation of the two comparators CM1 and CM2. In this third embodiment, the pixel signals read out from the pixels in different rows of the same column are time-divisionally AD-converted on the basis of the switching operation of an input of a single comparator.

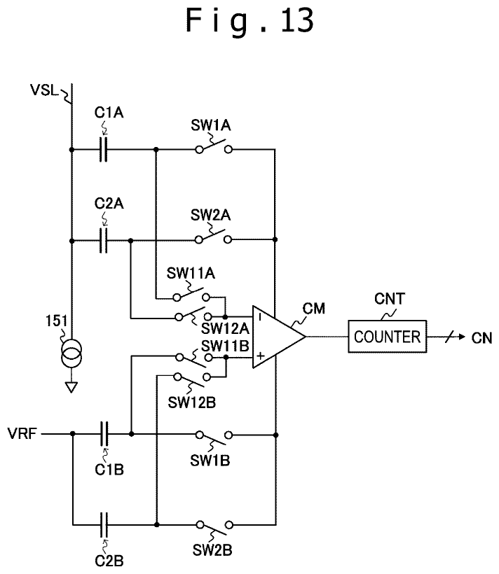

FIG. 13 is a block diagram depicting a configuration example of the AD conversion section of one column of the solid-state imaging device according to the third embodiment.

In the drawing, this solid-state imaging device includes a comparator CM and switches SW11A, SW11B, SW12A, and SW12B instead of the comparators CM1 and CM2 of the first embodiment described above. Other configurations of the solid-state imaging device of the third embodiment are similar to the configurations of the solid-state imaging device of the first embodiment described above.

The switches SW11A and SW12A can switch an input, to the comparator CM, of the pixel signals of the pixels PIX1 and PIX2 transmitted through the same vertical signal line VSL. The switches SW11B and SW12B can switch the capacitors C1B and C2B used for inputting the reference signal VRF in accordance with the switching of the input, to the comparator CM, of the pixel signals of the pixels PIX1 and PIX2.

The switch SW11A is connected between an inverting input terminal of the comparator CM and the capacitor C1A. The switch SW12A is connected between the inverting input terminal of the comparator CM and the capacitor C2A. The switch SW11B is connected between a non-inverting input terminal of the comparator CM and the capacitor C1B. The switch SW12B is connected between the non-inverting input terminal of the comparator CM and the capacitor C2B. An output of the comparator CM is input to the counter CNT.

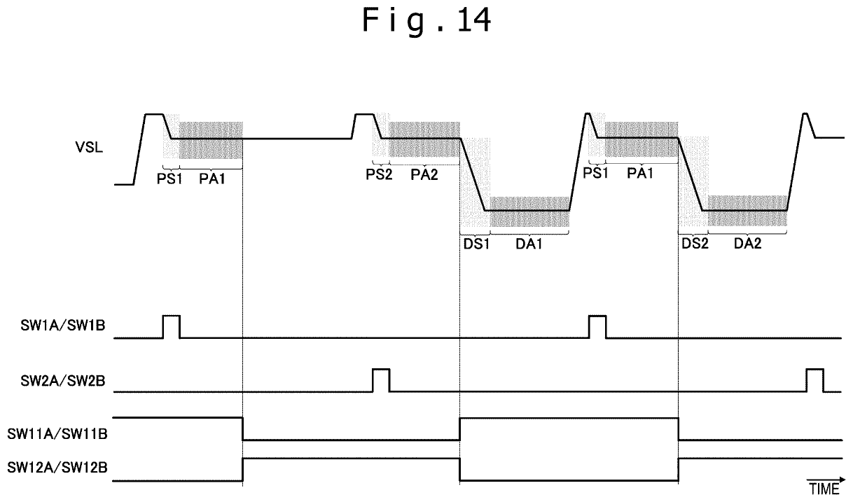

FIG. 14 is a timing chart depicting an operation example of the AD conversion section of one column of the solid-state imaging device according to the third embodiment.

In the drawing, in the P-phase settling period PS1 and the P-phase AD conversion period PA1 of the pixel PIX1, the switches SW11A and SW11B are turned on, and the switches SW12A and SW12B are turned off. At this time, the pixel signal of the pixel PIX1 is input to the comparator CM. Further, the auto-zero switches SW1A and SW1B are turned on in the P-phase settling period PS1, and thus charge is accumulated in the capacitors C1A and C1B so as to balance the inverting input and the non-inverting input of the comparator CM.

On the other hand, in the P-phase settling period PS2 and the P-phase AD conversion period PA2 of the pixel PIX2, the switches SW11A and SW11B are turned off, and the switches SW12A and SW12B are turned on. At this time, the pixel signal of the pixel PIX2 is input to the comparator CM. Further, the auto-zero switches SW2A and SW2B are turned on in the P-phase settling period PS2, and thus charge is accumulated in the capacitors C2A and C2B so as to balance the inverting input and the non-inverting input of the comparator CM.

Thus, in the third embodiment described above, the pixel signals read out from the pixels in different rows of the same column are time-divisionally AD-converted on the basis of the switching operation of the input of the single comparator CM. This makes it possible to eliminate the need for a waiting period before AD conversion of each of the pixels PIX1 and PIX2 in the same column while suppressing an increase in the circuit scale of the AD conversion section.

### 4. Fourth Embodiment

In the third embodiment described above, the pixel signals read out from the pixels in different rows of the same column are time-divisionally AD-converted on the basis of the switching operation of the input of the single comparator CM. In this fourth embodiment, a switch for time-divisionally AD-converting the pixel signals read out from the pixels in different rows of the same column on the basis of the switching operation of the input of a single comparator and for switching the input is built into the comparator.

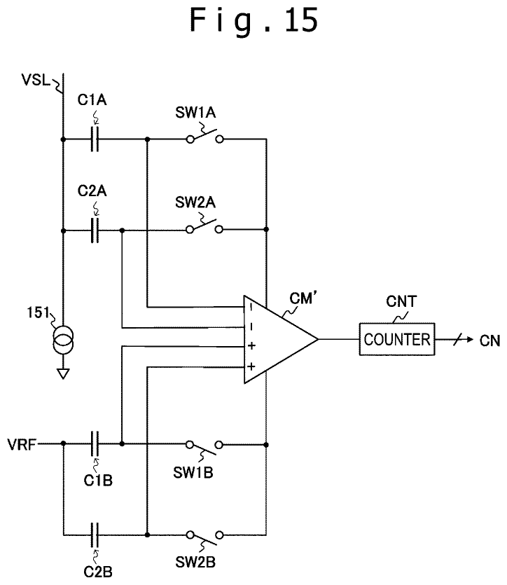

FIG. 15 is a block diagram depicting a configuration example of the AD conversion section of one column of the solid-state imaging device according to the fourth embodiment.

In the drawing, this solid-state imaging device includes a comparator CM′ instead of the comparator CM of the third embodiment described above. The switches SW11A, SW11B, SW12A, and SW12B of the third embodiment described above are built into the comparator CM′. At this time, the comparator CM′ is provided with an inverting input terminal corresponding to the switches SW11A and SW11B, and a non-inverting input terminal corresponding to the switches SW12A and SW12B. Other configurations of the solid-state imaging device of the fourth embodiment are similar to the configurations of the solid-state imaging device of the third embodiment described above. The comparator CM′ can operate at a timing similar to that of the comparator CM of the third embodiment described above.

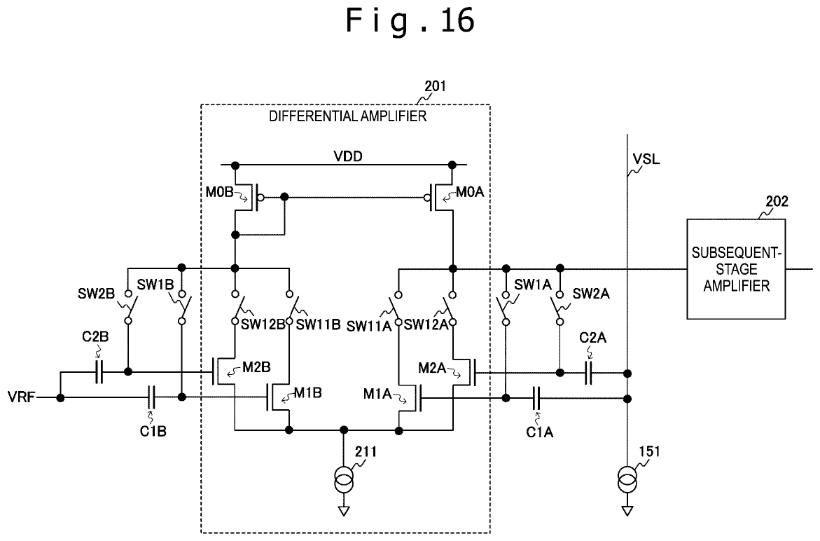

FIG. 16 is a diagram depicting a configuration example of the comparator of one column of the solid-state imaging device according to the fourth embodiment.

In the drawing, the comparator CM′ includes a differential amplifier 201 and a subsequent-stage amplifier 202. The subsequent-stage amplifier 202 is connected to a subsequent stage of the differential amplifier 201. The subsequent-stage amplifier 202 may be a multistage amplifier.

The differential amplifier 201 includes P-channel field-effect transistors M0A and M0B, N-channel field-effect transistors M1A, M1B, M2A, and M2B, the switches SW11A, SW11B, SW12A, and SW12B, and a current source 211.

The P-channel field-effect transistor M0A can form a differential pair with each of the N-channel field-effect transistors M1A and M2A. The P-channel field-effect transistor M0B can form a differential pair with each of the N-channel field-effect transistors M1B and M2B. The P-channel field-effect transistors M0A and M0B can form a current mirror.

Sources of the P-channel field-effect transistors M0A and M0B are connected to the power source potential VDD. Gates of the P-channel field-effect transistor M0A and M0B are connected to a drain of the P-channel field-effect transistor M0B.

The switch SW11A is connected between a drain of the P-channel field-effect transistor M0A and a drain of the N-channel field-effect transistor M1A. The switch SW12A is connected between a drain of the P-channel field-effect transistor M0A and a drain of the N-channel field-effect transistor M2A. The switch SW11B is connected between the drain of the P-channel field-effect transistor M0B and a drain of the N-channel field-effect transistor M1B. The switch SW12B is connected between the drain of the P-channel field-effect transistor M0B and a drain of the N-channel field-effect transistor M2B. Sources of the N-channel field-effect transistors M1A, M2A, M1B, and M2B are grounded via the current source 211.

The auto-zero switch SW1A is connected between the drain of the P-channel field-effect transistor M0A and a gate of the N-channel field-effect transistor M1A. The auto-zero switch SW2A is connected between the drain of the P-channel field-effect transistor M0A and a gate of the N-channel field-effect transistor M2A. The auto-zero switch SW1B is connected between the drain of the P-channel field-effect transistor M0B and a gate of the N-channel field-effect transistor M1B. The auto-zero switch SW2B is connected between the drain of the P-channel field-effect transistor M0B and a gate of the N-channel field-effect transistor M2B.

The capacitor C1A is connected between the vertical signal line VSL and the gate of the N-channel field-effect transistor M1A. The capacitor C2A is connected between the vertical signal line VSL and the gate of the N-channel field-effect transistor M2A. The reference signal VRF is input to the gate of the N-channel field-effect transistor M1B via the capacitor C1B. The reference signal VRF is input to the gate of the N-channel field-effect transistor M2B via the capacitor C2B.

Thus, in the fourth embodiment described above, the pixel signals read out from the pixels in different rows of the same column are time-divisionally AD-converted on the basis of the switching operation of the input of the single comparator CM′. At this time, the switches SW11A, SW11B, SW12A, and SW12B for switching the input are built into the comparator CM′. This makes it possible to time-divisionally AD-convert the pixel signals read out from the pixels PIX1 and PIX2 in different rows of the same column while suppressing the influence of charge injection and feedthrough caused by the input switching operation of the single comparators CM′ from being transmitted to the capacitors C1A, C1B, C2A, and C2B.

Note that the comparator CM′ may be used for AD conversion of analog signals such as audio signals, temperature, pressure, flow velocity, wind velocity, and vehicle speed, in addition to AD conversion of pixel signals. Alternatively, the comparator CM′ may be used for comparison between a signal other than the signal used for AD conversion and a threshold, or the like.

### 5. Fifth Embodiment

In the fourth embodiment described above, the switches SW11A, SW11B, SW12A, and SW12B for switching the input are built into the comparator CM′. In this fifth embodiment, the switches SW11A and SW11B for switching the input are built into the comparator, and the auto-zero operation on the input side of the reference signal VRF is omitted.

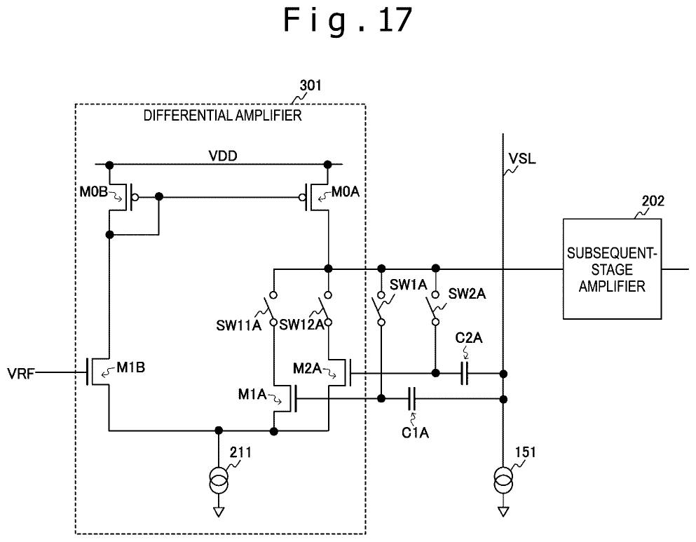

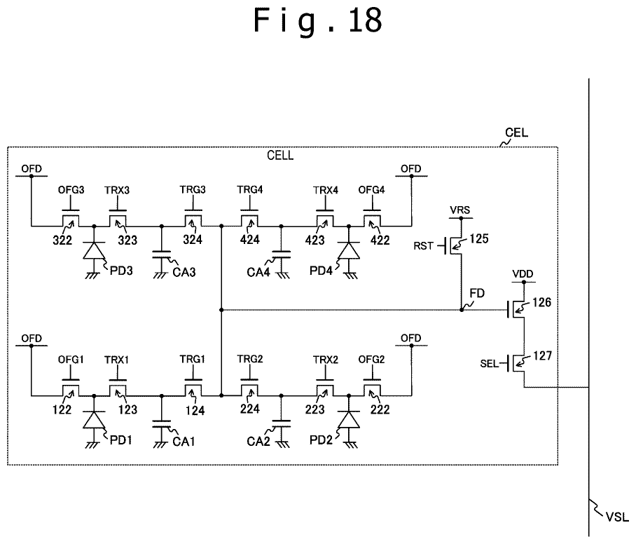

FIG. 17 is a diagram depicting a configuration example of the comparator of one column of the solid-state imaging device according to the fifth embodiment.

In the drawing, this solid-state imaging device includes a differential amplifier 301 instead of the differential amplifier 201 of the fourth embodiment described above. Further, in this solid-state imaging device, the auto-zero switches SW1B and SW2B and the capacitors C1B and C2B of the fourth embodiment described above are removed. Other configurations of the solid-state imaging device of the fifth embodiment are similar to the configurations of the solid-state imaging device of the fourth embodiment described above.

The differential amplifier 301 is obtained by removing the N-channel field-effect transistor M2B and the switches SW11B and SW12B from the differential amplifier 201 of the fourth embodiment described above. At this time, the drain of the N-channel field-effect transistor M1B is connected to the drain of the P-channel field-effect transistor M0B. Other configurations of the differential amplifier 301 of the fifth embodiment are similar to the configurations of the differential amplifier 201 of the fourth embodiment described above.

In the differential amplifier 301, the switching of the auto-zero switches SW1A and SW2A and the switches SW11A and SW12A is similar to the switching of the differential amplifier 201 of the fourth embodiment described above. At this time, in the differential amplifier 301, the auto-zero operation is implemented on the input side of the pixel signals via the vertical signal line VSL, and the auto-zero operation is omitted on the input side of the reference signal VRF. Therefore, desirably the auto-zero potential depends on the potential of the reference signal VRF, ensuring the accuracy of the potential of the reference signal VRF in terms of absolute value.

Thus, in the fifth embodiment described above, the switches SW11A and SW11B for switching the input are built into the comparator, and the auto-zero operation in the input side of the reference signal VRF is omitted. This eliminates the need for the auto-zero switches SW1B and SW2B, the switches SW11B and SW12B, and the capacitors C1B and C2B on the input side of the reference signal VRF. This makes it possible to suppress the influence of charge injection and feedthrough caused by the switching operation of the input of the single comparator while suppressing an increase in circuit scale of the AD conversion section.

### 6. Sixth Embodiment

In the first embodiment described above, for the pixels to which the charge domain is applied, the pixel signals read out from the pixels in different rows of the same column are time-divisionally AD-converted. In this sixth embodiment, for four-pixel shared cells to which a charge domain is applied, the pixel signals read out from the pixels in different rows of the same column are time-divisionally AD-converted.

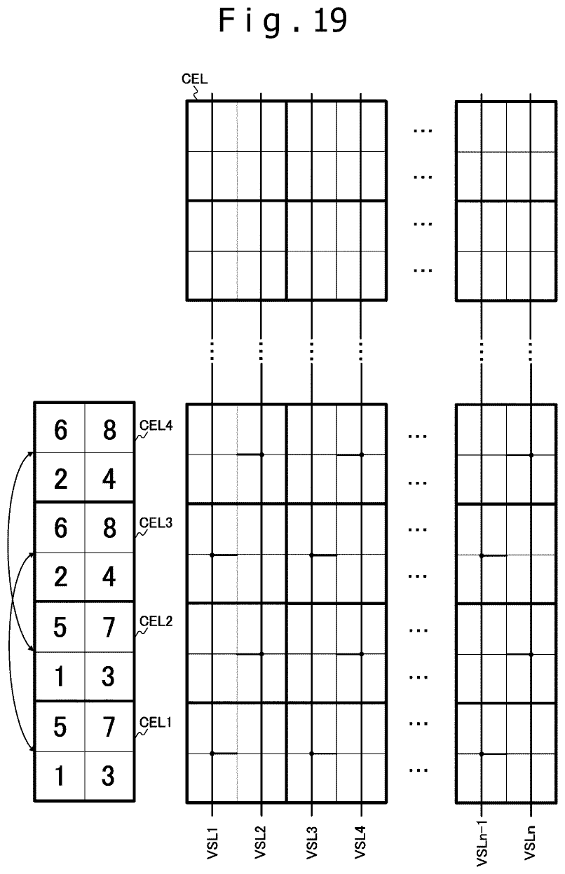

FIG. 18 is a diagram depicting a circuit configuration example of the pixels of the solid-state imaging device according to the sixth embodiment.

In the drawing, this solid-state imaging device includes a four-pixel shared cell CEL instead of the pixel PIX of the first embodiment described above. Other configurations of the solid-state imaging device of the sixth embodiment are similar to the configurations of the solid-state imaging device of the first embodiment described above.

The four-pixel shared cell CEL is obtained by adding, to the pixel PIX1 of the first embodiment described above, photodiodes PD2 to PD4, capacitors CA2 to CA4, transfer transistors 223, 224, 323, 324, 423, and 424, and overflow control transistors 222 to 422. The connection relationship between the photodiodes PD2 to PD4, the capacitors CA2 to CA4, the transfer transistors 223, 224, 323, 324, 423, and 424, and the overflow control transistors 222 to 422 is similar to the connection relationship between the photodiode PD1, the capacitor CA1, the transfer transistors 123 and 124, and the overflow control transistor 122.

At this time, the floating diffusion FD1, the reset transistor 125, the output transistor 126, and the selection transistor 127 are shared by the four photodiodes PD1 to PD4 and the four capacitors CA1 to CA4. A reset signal RST is applied to the gate of the reset transistor 125, and a selection signal SEL is applied to the gate of the selection transistor 127. In the four-pixel shared cell CEL, the pixels can be arranged in a 2×2 array. At this time, in the four-pixel shared cell CEL, colorization can be implemented on the basis of a Bayer array.

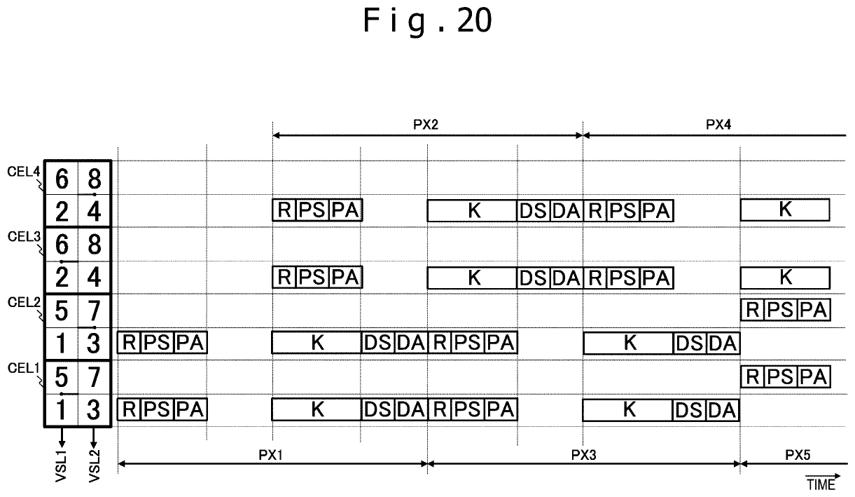

FIG. 19 is a diagram depicting a readout order of the pixels of the solid-state imaging device according to the sixth embodiment.

In the drawing, the four-pixel shared cells CEL are arrayed in a matrix in the row direction and the column direction. At this time, when vertical signal lines VSL1 to VSLn (n being an even number) are arranged for each column, the four-pixel shared cells CEL adjacent to each other in the column direction are connected to the vertical signal lines VSL1 to VSLn different from each other. At this time, the four-pixel shared cells CEL in the same column are alternately connected to the same vertical signal lines VSL1 to VSLn. For example, for four-pixel shared cells CEL1 to CEL4 disposed adjacent to each other in the same column, the four-pixel shared cells CEL1 and CEL3 are connected to the vertical signal line VSL1, and the four-pixel shared cells CEL2 and CEL4 are connected to the vertical signal line VSL2.

In the readout from the four-pixel shared cell CELs, for example, the pixel signals can be alternately read out from the pixels of the four-pixel shared cells CEL1 and CEL3 while simultaneously alternately reading out the pixel signals from the pixels of the four-pixel shared cells CEL2 and CEL4. At this time, the pixel signals are read out from the pixels of the four-pixel shared cells while straddling two four-pixel shared cells adjacent in the column direction. For example, from each pixel of the four-pixel shared cells CEL1 to CEL4, the pixel signals are read out in the order of 1→2→3→4→5→6'7→8 by going back and forth between the four-pixel shared cells CEL1 and CEL3 in the column direction and going back and forth between the four-pixel shared cells CEL2 and CEL4 in the column direction.

FIG. 20 is a timing chart depicting operation of the solid-state imaging device according to the sixth embodiment. Note that R indicates a reset period, PS indicates a P-phase settling period, PA indicates a P-phase AD conversion period, K indicates a transfer period from the capacitor to the floating diffusion, DS indicates a D-phase settling period, and DA indicates a D-phase AD conversion period.

In the drawing, in a first readout period PX1, the P-phase pixel signals and the D-phase pixel signals are sequentially read out from the first pixels of the four-pixel shared cells CEL1 and CEL2, and sequentially transmitted through the vertical signal lines VSL1 and VSL2.

In a second readout period PX2, the P-phase pixel signals and the D-phase pixel signals are sequentially read out from the first pixels of the four-pixel shared cells CEL3 and CEL4, and sequentially transmitted through the vertical signal lines VSL1 and VSL2. At this time, the reset periods R, the P-phase settling periods PS, and the P-phase AD conversion periods PA of the first pixels of the four-pixel shared cells CEL3 and CEL4 overlap the transfer periods K of the first pixels of the four-pixel shared cells CEL1 and CEL2.

In a third readout period PX3, the P-phase pixel signals and the D-phase pixel signals are sequentially read out from the second pixels of the four-pixel shared cells CEL1 and CEL2, and sequentially transmitted through the vertical signal lines VSL1 and VSL2. At this time, the reset periods R, the P-phase settling periods PS, and the P-phase AD conversion periods PA of the second pixels of the four-pixel shared cells CEL1 and CEL2 overlap the transfer periods K of the first pixels of the four-pixel shared cells CEL3 and CEL4.

In a fourth readout period PX4, the P-phase pixel signals and the D-phase pixel signals are sequentially read out from the second pixels of the four-pixel shared cells CEL3 and CEL4, and sequentially transmitted through the vertical signal lines VSL1 and VSL2. At this time, the reset periods R, the P-phase settling periods PS, and the P-phase AD conversion periods PA of the second pixels of the four-pixel shared cells CEL3 and CEL4 overlap the transfer periods K of the second pixels of the four-pixel shared cells CEL1 and CEL2.

In a fifth readout period PX5, the P-phase pixel signals and the D-phase pixel signals are sequentially read out from the third pixels of the four-pixel shared cells CEL1 and CEL2, and sequentially transmitted through the vertical signal lines VSL1 and VSL2. At this time, the reset periods R, the P-phase settling periods PS, and the P-phase AD conversion periods PA of the third pixels of the four-pixel shared cells CEL1 and CEL2 overlap the transfer periods K of the second pixels of the four-pixel shared cells CEL3 and CEL4.

At this time, under the condition that the total time of the reset period R, the P-phase settling period PS, and the P-phase AD conversion period PA is equal to the time of the transfer period K, the speed can be increased by 1.67 times as compared with a case in which the reset period R, the P-phase settling period PS, and the P-phase AD conversion period PA are put on standby during the transfer period K. However, in the sixth embodiment, the row of the transfer mode and the row of the P-phase mode exist at the same timing. This makes it necessary to perform control for operating a certain row in the P-phase mode at a timing of operating another row in the transfer mode.

Thus, in the sixth embodiment described above, for the four-pixel shared cells to which a charge domain is applied, the pixel signals read out from the pixels in different rows of the same column are time-divisionally AD-converted. This makes it possible to eliminate the need for a waiting period before AD conversion for the pixels in different rows of the same column while suppressing an increase in the size of the pixels to which the charge domain is applied.

### 7. Seventh Embodiment

In the sixth embodiment described above, the reset periods R, the P-phase settling periods PS, and the P-phase AD conversion periods PA of the four-pixel shared cells CEL in different rows of the same column are made to overlap the transfer periods K. In this seventh embodiment, the reset periods R of the four-pixel shared cells CEL in different rows of the same column are made to not overlap the transfer periods K.

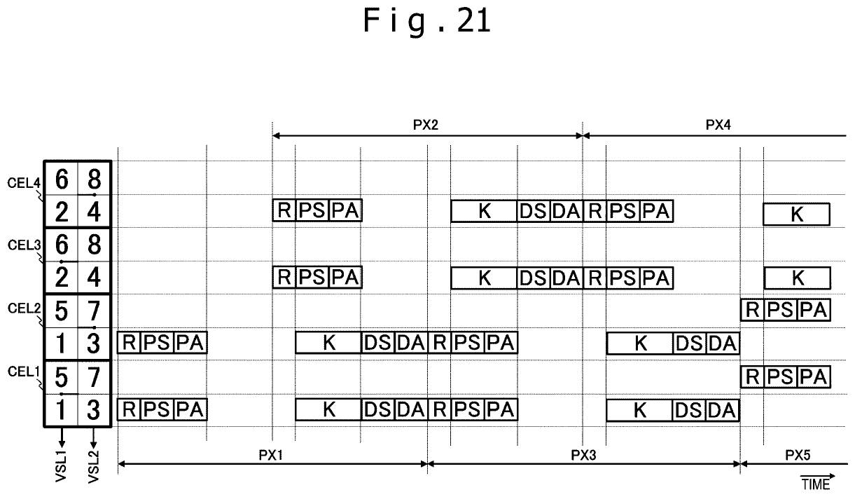

FIG. 21 is a timing chart depicting operation of the solid-state imaging device according to the seventh embodiment.

In the drawing, the configuration and the readout order of the four-pixel shared cells CEL of the seventh embodiment are similar to the configuration and the readout order of the four-pixel shared cells CEL of the sixth embodiment. However, in the seventh embodiment, the P-phase settling periods PS and the P-phase AD conversion periods PA of the four-pixel shared cells CEL in different rows of the same column overlap the transfer periods K, and the reset periods R do not overlap the transfer periods K. At this time, by individually controlling the selection signal SEL for each row, it is no longer necessary to prepare the P-phase mode and the D-phase mode, and the row of the reset mode and the row of the transfer mode do not exist at the same timing, making it possible to treat the modes as a common mode. However, with the reset period R not overlapping the transfer period K, the time taken for the reset period R is added to the time taken for the transfer period K.

Thus, in the seventh embodiment described above, the reset periods R of the four-pixel shared cells CEL in different rows of the same column are made to not overlap the transfer periods K. This makes it possible to eliminate the need to prepare the P-phase mode and the D-phase mode and make the row in the reset mode and the row in the transfer mode not exist at the same timing, and thus simplify readout control.

### 8. Eighth Embodiment

In the sixth embodiment described above, in the four-pixel shared cell CEL to which a charge domain is applied, the pixel signals read out from the pixels in different rows of the same column are time-divisionally AD-converted. In this eighth embodiment, for a two-pixel shared cell to which a charge domain is applied, the pixel signals read out from the pixels in different rows of the same column are time-divisionally AD-converted, and the reset periods R are made to not overlap the transfer periods K.

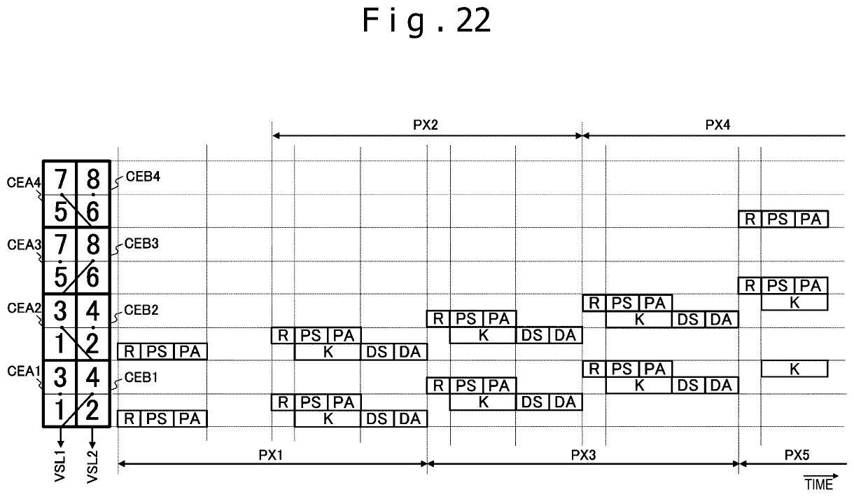

FIG. 22 is a timing chart depicting operation of the solid-state imaging device according to the eighth embodiment.

In the drawing, two-pixel shared cells CEA1 to CEA4 and CEB1 to CEB4 are arrayed in a matrix in the row direction and the column direction. In the respective two-pixel shared cells CEA1 to CEA4 and CEBI to CEB4, the pixels can be arranged in a 1×2 array. At this time, under the assumption that the vertical signal lines VSL1 to VSLn are arranged for each column, the two-pixel shared cells in the same column are connected to the same vertical signal lines VSL1 to VSLn, and the two-pixel shared cells in different columns are connected to the vertical signal lines VSL1 to VSLn that differ from each other. For example, the two-pixel shared cells CEA1 to CEA4 in the same column are connected to the vertical signal line VSL1, and the two-pixel shared cells CEB1 to CEB4 in the same column are connected to the vertical signal line VSL2.

In the readout from the two-pixel shared cells, for example, the pixel signals are simultaneously read out from the first pixels of the two-pixel shared cells CEA1 and CEA2 to the vertical signal lines VSL1 and VSL2, and then the pixel signals are simultaneously read out from the first pixels of the two-pixel shared cells CEB1 and CEB2 to the vertical signal lines VSL1 and VSL2. Furthermore, the pixel signals are simultaneously read out from the second pixels of the two-pixel shared cells CEA1 and CEA2 to the vertical signal lines VSL1 and VSL2, and then the pixel signals are simultaneously read out from the second pixels of the two-pixel shared cells CEB1 and CEB2 to the vertical signal lines VSL1 and VSL2. Subsequently, the pixel signals are simultaneously read out from the first pixels of the two-pixel shared cells CEA3 and CEA4 to the vertical signal lines VSL1 and VSL2, and then the pixel signals are simultaneously read out from the first pixels of the two-pixel shared cells CEB3 and CEB4 to the vertical signal lines VSL1 and VSL2. Furthermore, the pixel signals are simultaneously read out from the second pixels of the two-pixel shared cells CEA3 and CEA4 to the vertical signal lines VSL1 and VSL2, and then the pixel signals are simultaneously read out from the second pixels of the two-pixel shared cells CEB3 and CEB4 to the vertical signal lines VSL1 and VSL2. At this time, the pixel signals are read out from the pixels of the two-pixel shared cells CEA1, CEA2, CEB1, and CEB2 in the order of 1→2→3→4, and subsequently the pixel signals are read out from the pixels of the two-pixel shared cells CEA3, CEA4, CEB3, and CEB4 in the order of 5→6→7→8. In the readout from each pixel of the two-pixel shared cells CEA1, CEA2, CEB1, and CEB2, the readout does not go back and forth in the column direction between the two-pixel shared cells CEA1, CEA2, CEB1, and CEB2.

In the first readout period PX1, the P-phase pixel signals and the D-phase pixel signals are sequentially read out from the first pixels of the two-pixel shared cells CEA1 and CEA2, and sequentially transmitted through the vertical signal lines VSL1 and VSL2.

In the second readout period PX2, the P-phase pixel signals and the D-phase pixel signals are sequentially read out from the second pixels of the two-pixel shared cells CEA1 and CEA2, and sequentially transmitted through the vertical signal lines VSL1 and VSL2. At this time, the P-phase settling periods PS and the P-phase AD conversion periods PA of the second pixels of the two-pixel shared cells CEA1 and CEA2 overlap the transfer periods K of the first pixels of the two-pixel shared cells CEA1 and CEA2. The reset periods R of the second pixels of the two-pixel shared cells CEA1 and CEA2 do not overlap the transfer periods K of the first pixels of the two-pixel shared cells CEA1 and CEA2.

In the third readout period PX3, the P-phase pixel signals and the D-phase pixel signals are sequentially read out from the first pixels of the two-pixel shared cells CEB1 and CEB2, and sequentially transmitted through the vertical signal lines VSL1 and VSL2. At this time, the P-phase settling periods PS and the P-phase AD conversion periods PA of the first pixels of the two-pixel shared cells CEB1 and CEB2 overlap the transfer periods K of the second pixels of the two-pixel shared cells CEA1 and CEA2. The reset periods R of the first pixels of the two-pixel shared cells CEB1 and CEB2 do not overlap the transfer periods K of the second pixels of the two-pixel shared cells CEA1 and CEA2.

In the fourth readout period PX4, the P-phase pixel signals and the D-phase pixel signals are sequentially read out from the second pixels of the two-pixel shared cells CEB1 and CEB2, and sequentially transmitted through the vertical signal lines VSL1 and VSL2. At this time, the P-phase settling periods PS and the P-phase AD conversion periods PA of the second pixels of the two-pixel shared cells CEB1 and CEB2 overlap the transfer periods K of the first pixels of the two-pixel shared cells CEB1 and CEB2. The reset periods R of the second pixels of the two-pixel shared cells CEB1 and CEB2 do not overlap the transfer periods K of the first pixels of the two-pixel shared cells CEB1 and CEB2.

In the fifth readout period PX5, the P-phase pixel signals and the D-phase pixel signals are sequentially read out from the first pixels of the two-pixel shared cells CEA3 and CEA4, and sequentially transmitted through the vertical signal lines VSL1 and VSL2. At this time, the P-phase settling periods PS and the P-phase AD conversion periods PA of the first pixels of the two-pixel shared cells CEA3 and CEA4 overlap the transfer periods K of the second pixels of the two-pixel shared cells CEB1 and CEB2. The reset periods R of the first pixels of the two-pixel shared cells CEA3 and CEA4 do not overlap the transfer periods K of the second pixels of the two-pixel shared cells CEB1 and CEB2.

Thus, in the eighth embodiment described above, in the two-pixel shared cells to which a charge domain is applied, the pixel signals read out from the pixels in different rows of the same column are time-divisionally AD-converted, and the reset periods R are made to not overlap the transfer periods K. This eliminates the need to straddle the two-pixel shared cells in the column direction during readout from each pixel of the two-pixel shared cells, making it possible to suppress an increase in time lag until completion of readout from each pixel of the two-pixel shared cells.

### 9. Ninth Embodiment

In the seventh embodiment described above, the reset periods R of the four-pixel shared cells CEL in different rows of the same column are made to not overlap the transfer periods K. In this ninth embodiment, the reset periods R of the four-pixel shared cells in different rows of the same column are made to not overlap the transfer periods K and made to overlap the D-phase AD conversion periods DA.

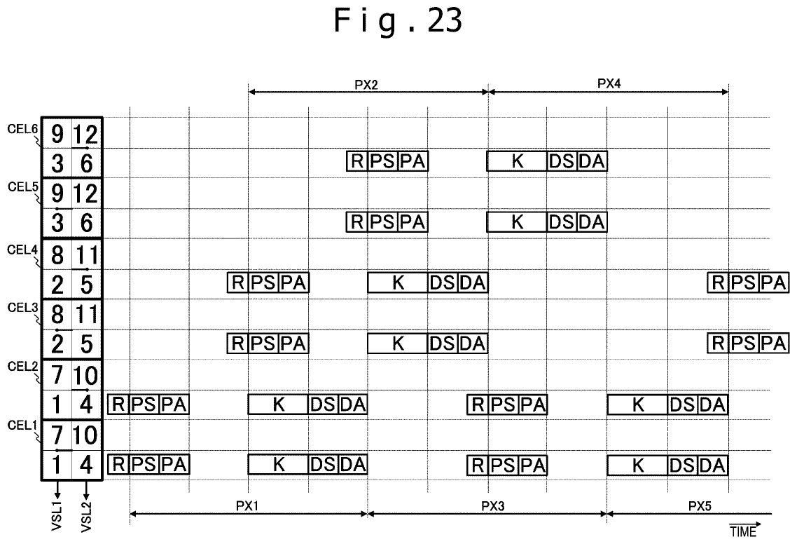

FIG. 23 is a timing chart depicting operation of the solid-state imaging device according to the ninth embodiment.

In the drawing, four-pixel shared cells CEL1 to CEL6 are arranged in the column direction. In the readout from the four-pixel shared cells CEL1 to CEL6, for example, the pixel signals can be sequentially read out from the pixels of the four-pixel shared cells CEL1, CEL3, and CEL5 while simultaneously sequentially reading out the pixel signals from the pixels of the four-pixel shared cells CEL2, CEL4, and CEL6. At this time, the pixel signals are read out from the pixels of the four-pixel shared cells while straddling three four-pixel shared cells adjacent in the column direction. For example, the pixel signals are read out from the pixels in the four-pixel shared cells CEL1 to CEL6 in the order of 1→2→3→4→5→6→7→8→9→10→11→12.

In the first readout period PX1, the P-phase pixel signals and the D-phase pixel signals are sequentially read out from the first pixels of the four-pixel shared cells CEL1 and CEL2, and sequentially transmitted through the vertical signal lines VSL1 and VSL2. At this time, the reset periods R of the first pixels of the four-pixel shared cells CEL3 and CEL4 are implemented early in the readout period PX1. Here, the reset periods R of the first pixels of the four-pixel shared cells CEL3 and CEL4 do not overlap the transfer periods K of the first pixels of the four-pixel shared cells CEL1 and CEL2.

In the second readout period PX2, the P-phase pixel signals and the D-phase pixel signals are sequentially read out from the first pixels of the four-pixel shared cells CEL3 and CEL4, and sequentially transmitted through the vertical signal lines VSL1 and VSL2. At this time, the reset periods R of the first pixels of the four-pixel shared cells CEL5 and CEL6 are implemented early in the readout period PX2. Here, the P-phase settling periods PS and the P-phase AD conversion periods PA of the first pixels of the four-pixel shared cells CEL3 and CEL4 overlap the transfer periods K of the first pixels of the four-pixel shared cells CEL1 and CEL2. Further, the reset periods R of the first pixels of the four-pixel shared cells CEL5 and CEL6 overlap the D-phase AD conversion periods DA of the first pixels of the four-pixel shared cells CEL1 and CEL2, and do not overlap the transfer periods K of the first pixels of the four-pixel shared cells CEL3 and CEL4.

In the third readout period PX3, the P-phase pixel signals and the D-phase pixel signals are sequentially read out from the first pixels of the four-pixel shared cells CEL5 and CEL6, and sequentially transmitted through the vertical signal lines VSL1 and VSL2. At this time, the reset periods R of the second pixels of the four-pixel shared cells CEL1 and CEL2 are implemented early in the readout period PX3. Here, the P-phase settling periods PS and the P-phase AD conversion periods PA of the first pixels of the four-pixel shared cells CEL5 and CEL6 overlap the transfer periods K of the first pixels of the four-pixel shared cells CEL3 and CEL4. Further, the reset periods R of the second pixels of the four-pixel shared cells CEL1 and CEL2 overlap the D-phase AD conversion periods DA of the first pixels of the four-pixel shared cells CEL3 and CEL4, and do not overlap the transfer periods K of the first pixels of the four-pixel shared cells CEL5 and CEL6.

In the fourth readout period PX4, the P-phase pixel signals and the D-phase pixel signals are sequentially read out from the second pixels of the four-pixel shared cells CEL1 and CEL2, and sequentially transmitted through the vertical signal lines VSL1 and VSL2. At this time, the reset periods R of the second pixels of the four-pixel shared cells CEL3 and CEL4 are implemented early in the readout period PX4. Here, the P-phase settling periods PS and the P-phase AD conversion periods PA of the second pixels of the four-pixel shared cells CEL1 and CEL2 overlap the transfer periods K of the first pixels of the four-pixel shared cells CEL5 and CEL6. Further, the reset periods R of the second pixels of the four-pixel shared cells CEL3 and CEL4 overlap the D-phase AD conversion periods DA of the second pixels of the four-pixel shared cells CEL1 and CEL2, and do not overlap the transfer periods K of the second pixels of the four-pixel shared cells CEL1 and CEL2.

In the fifth readout period PX5, the P-phase pixel signals and the D-phase pixel signals are sequentially read out from the second pixels of the four-pixel shared cells CEL3 and CEL4, and sequentially transmitted through the vertical signal lines VSL1 and VSL2.

Thus, in the ninth embodiment described above, the reset periods R of the four-pixel shared cells in different rows of the same column are made to not overlap the transfer periods K and made to overlap the D-phase AD conversion periods DA. This makes it possible to implement the reset periods R early during the D-phase AD conversion periods DA of the four-pixel shared cells in different rows of the same column and increase the speed of readout from the four-pixel shared cells.

### 10. Tenth Embodiment

In the ninth embodiment described above, the reset periods R of the four-pixel shared cells in different rows of the same column are made to not overlap the transfer periods K and made to overlap the D-phase AD conversion periods DA. In this tenth embodiment, the reset periods R of two-pixel shared cells in different rows of the same column are made to not overlap the transfer periods K and made to overlap the D-phase AD conversion periods DA.

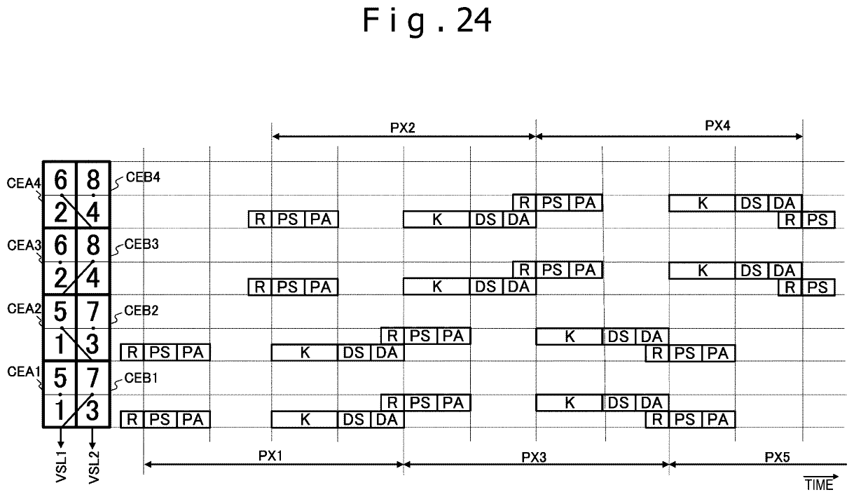

FIG. 24 is a timing chart depicting operation of the solid-state imaging device according to the tenth embodiment.

In the drawing, in the readout from the two-pixel shared cells, for example, the pixel signals are simultaneously read out from the first pixels of the two-pixel shared cells CEA1 and CEA2 to the vertical signal lines VSL1 and VSL2, and then the pixel signals are simultaneously read out from the first pixels of the two-pixel shared cells CEA3 and CEA4 to the vertical signal lines VSL1 and VSL2. Furthermore, the pixel signals are simultaneously read out from the first pixels of the two-pixel shared cells CEB1 and CEB2 to the vertical signal lines VSL1 and VSL2, and then the pixel signals are simultaneously read out from the first pixels of the two-pixel shared cells CEB3 and CEB4 to the vertical signal lines VSL1 and VSL2. Subsequently, the pixel signals are simultaneously read out from the second pixels of the two-pixel shared cells CEA1 and CEA2 to the vertical signal lines VSL1 and VSL2, and then the pixel signals are simultaneously read out from the second pixels of the two-pixel shared cells CEA3 and CEA4 to the vertical signal lines VSL1 and VSL2. Furthermore, the pixel signals are simultaneously read out from the second pixels of the two-pixel shared cells CEB1 and CEB2 to the vertical signal lines VSL1 and VSL2, and then the pixel signals are simultaneously read out from the second pixels of the two-pixel shared cells CEB3 and CEB4 to the vertical signal lines VSL1 and VSL2. At this time, the pixel signals are read out from the pixels in the two pixel shared cells from CEA1 to CEA4 and from CEB1 to CEB4 in the order of 1→2→3→4→5→6→7→8.

In the first readout period PX1, the P-phase pixel signals and the D-phase pixel signals are sequentially read out from the first pixels of the two-pixel shared cells CEA1 and CEA2, and sequentially transmitted through the vertical signal lines VSL1 and VSL2. At this time, the reset periods R of the first pixels of the two-pixel shared cells CEA3 and CEA4 are implemented early in the readout period PX1. Here, the reset periods R of the first pixels of the two-pixel shared cells CEA3 and CEA4 do not overlap the transfer periods K of the first pixels of the two-pixel shared cells CEA1 and CEA2.

In the second readout period PX2, the P-phase pixel signals and the D-phase pixel signals are sequentially read out from the first pixels of the two-pixel shared cells CEA3 and CEA4, and are sequentially transmitted through the vertical signal lines VSL1 and VSL2. At this time, the reset periods R of the first pixels of the two-pixel shared cells CEB1 and CEB2 are implemented early in the readout period PX2. Here, the P-phase settling periods PS and the P-phase AD conversion periods PA of the first pixels of the two-pixel shared cells CEA3 and CEA4 overlap the transfer periods K of the first pixels of the two-pixel shared cells CEA1 and CEA2. The reset periods R of the first pixels of the two-pixel shared cells CEB1 and CEB2 overlap the D-phase AD conversion periods DA of the first pixels of the two-pixel shared cells CEA1 and CEA2, and do not overlap the transfer periods K of the first pixels of the two-pixel shared cells CEA3 and CEA4.

In the third readout period PX3, the P-phase pixel signals and the D-phase pixel signals are sequentially read out from the first pixels of the two-pixel shared cells CEB1 and CEB2, and Sequentially transmitted through the vertical signal lines VSL1 and VSL2. At this time, the reset periods R of the first pixels of the two-pixel shared cells CEB3 and CEB4 are implemented early in the readout period PX3. Here, the P-phase settling periods PS and the P-phase AD conversion periods PA of the first pixels of the two-pixel shared cells CEB1 and CEB2 overlap the transfer periods K of the first pixels of the two-pixel shared cells CEA3 and CEA4. The reset periods R of the first pixels of the two-pixel shared cells CEB3 and CEB4 overlap the D-phase AD conversion periods DA of the first pixels of the two-pixel shared cells CEA3 and CEA4, and do not overlap the transfer periods K of the first pixels of the two-pixel shared cells CEB1 and CEB2.

In the fourth readout period PX4, the P-phase pixel signals and the D-phase pixel signals are sequentially read out from the first pixels of the two-pixel shared cells CEB3 and CEB4, and are sequentially transmitted through the vertical signal lines VSL1 and VSL2. At this time, the reset periods R of the second pixels of the two-pixel shared cells CEA1 and CEA2 are implemented early in the readout period PX4. Here, the P-phase settling periods PS and the P-phase AD conversion periods PA of the first pixels of the two-pixel shared cells CEB3 and CEB4 overlap the transfer periods K of the first pixels of the two-pixel shared cells CEB1 and CEB2. The reset periods R of the second pixels of the two-pixel shared cells CEA1 and CEA2 overlap the D-phase AD conversion periods DA of the first pixels of the two-pixel shared cells CEB1 and CEB2, and do not overlap the transfer periods K of the first pixels of the two-pixel shared cells CEB3 and CEB4.

In the fifth readout period PX5, the P-phase pixel signals and the D-phase pixel signals are sequentially read out from the second pixels of the two-pixel shared cells CEA1 and CEA2, and are sequentially transmitted through the vertical signal lines VSL1 and VSL2.

Thus, in the tenth embodiment described above, the reset periods R of two-pixel shared cells in different rows of the same column are made to not overlap the transfer periods K and made to overlap the D-phase AD conversion periods DA. This makes it possible to implement the reset periods R early during the D-phase AD conversion periods DA of the two-pixel shared cells in different rows of the same column and increase the speed of readout from the two-pixel shared cells. At this time, in the four-pixel shared cells, the readout operation straddles three four-pixel shared cells adjacent to each other in the column direction, whereas in the two-pixel shared cells, the read operation straddles two of the two-pixel shared cells adjacent to each other in the column direction. This makes it possible to suppress an increase in time lag until readout completion from each pixel of the two-pixel shared cells while increasing the speed of readout from the two-pixel shared cells.

### 11. Eleventh Embodiment

In the sixth embodiment described above, in the four-pixel shared cells to which a charge domain is applied, the pixel signals read out from the pixels in different rows of the same column are time-divisionally AD-converted. In this eleventh embodiment, it is possible to switch the processing of executing AD conversion in an overlapping manner during the transfer period of the charge held in the capacitor in the charge domain and the processing of putting AD conversion on standby during the transfer period of the charge held in the capacitor in the charge domain.

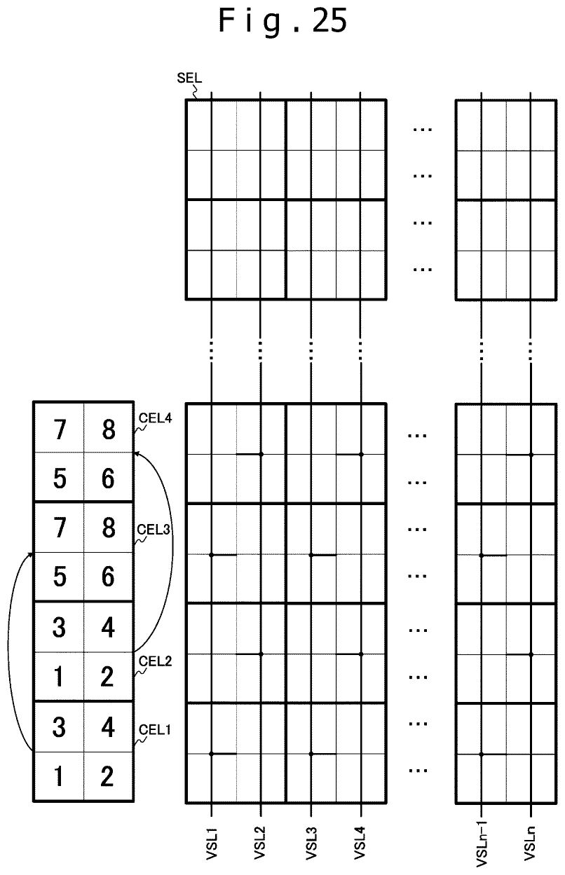

FIG. 25 is a diagram depicting a readout order of the pixels of the solid-state imaging device according to the eleventh embodiment. Note that the drawing depicts an example of putting AD conversion on standby during the transfer periods of the charge held in the capacitors of the four-pixel shared cells CEL1 to CEL4.

In the drawing, the solid-state imaging device can switch between the processing of executing AD conversion in an overlapping manner during the transfer periods of the charge held in the capacitors in the four-pixel shared cells CEL1 to CEL4 and the processing of putting AD conversion on standby during the transfer periods of the charge held in the capacitors in the four-pixel shared cells CEL1 to CEL4. The configuration of the four-pixel shared cells CEL1 to CEL4 is similar to the configuration of the four-pixel shared cells CEL1 to CEL4 in the sixth embodiment described above. Further, as the AD conversion section, for example, the comparator CM′ of the fourth embodiment described above can be used. At this time, in the processing of executing AD conversion in an overlapping manner in the transfer periods of the charge held in the capacitors of the four-pixel shared cells CEL1 to CEL4, the readout order of the pixels is set similarly to that in the sixth embodiment described above. At this time, the pixel signals are read out from each pixel of the four-pixel shared cells CEL1 to CEL4 while straddling two of the four-pixel shared cells CEL1 to CEL4 adjacent to each other in the column direction.

On the other hand, in the processing of putting the AD conversion on standby during the transfer periods of the charge held in the capacitors of the four-pixel shared cells CEL1 to CEL4, the pixel signals are read out from the pixels of the four-pixel shared cells CEL1 to CEL4 without straddling the four-pixel shared cells CEL1 to CEL4 disposed in the column direction.

At this time, the pixel signals are simultaneously read out from the first pixels of the four-pixel shared cells CEL1 and CEL2 to the vertical signal lines VSL1 and VSL2, and then the pixel signals are simultaneously read out from the second pixels of the four-pixel shared cells CEL1 and CEL2 to the vertical signal lines VSL1 and VSL2. Furthermore, the pixel signals are simultaneously read out from the third pixels of the four-pixel shared cells CEL1 and CEL2 to the vertical signal lines VSL1 and VSL2, and then the pixel signals are simultaneously read out from the fourth pixels of the four-pixel shared cells CEL1 and CEL2 to the vertical signal lines VSL1 and VSL2. Subsequently, the pixel signals are simultaneously read out from the first pixels of the four-pixel shared cells CEL3 and CEL4 to the vertical signal lines VSL1 and VSL2, and then the pixel signals are simultaneously read out from the second pixels of the four-pixel shared cells CEL3 and CEL4 to the vertical signal lines VSL1 and VSL2. Furthermore, the pixel signals are simultaneously read out from the third pixels of the four-pixel shared cells CEL3 and CEL4 to the vertical signal lines VSL1 and VSL2, and then the pixel signals are simultaneously read out from the fourth pixels of the four-pixel shared cells CEL3 and CEL4 to the vertical signal lines VSL1 and VSL2. At this time, the pixel signals are read out from the pixels of the four-pixel shared cells CEL1 and CEL2 in the order of 1→2→3→4, and then the pixel signals are read out from the pixels of the four-pixel shared cells CEL3 and CEL4 in the order of 5→6→7→8.

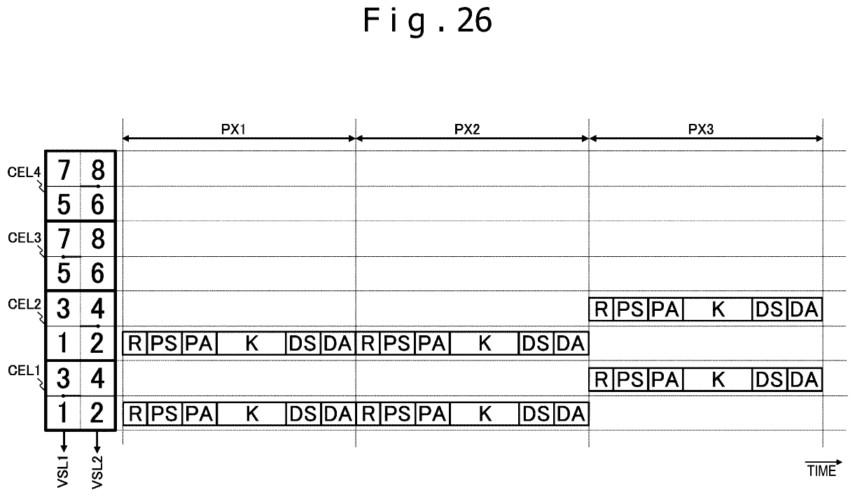

FIG. 26 is a timing chart depicting operation of the solid-state imaging device according to the eleventh embodiment. Note that the drawing depicts an example of putting AD conversion on standby during the transfer periods of the charge held in the capacitors of the four-pixel shared cells CEL1 to CEL4.

In the processing of executing AD conversion in an overlapping manner during the transfer periods of the charge held in the capacitors of the four-pixel shared cells CEL1 to CEL4, the operation is performed at a timing similar to that in the sixth embodiment described above, as depicted in FIG. 20.

On the other hand, in the processing of putting AD conversion on standby during the transfer periods of the charge held in the capacitors of the four-pixel shared cells CEL1 to CEL4, the operation is performed at the timing in FIG. 26.

At this time, in the first readout period PX1, the P-phase pixel signals and the D-phase pixel signals are sequentially read out from the first pixels of the four-pixel shared cells CEL1 and CEL2, and sequentially transmitted through the vertical signal lines VSL1 and VSL2. At this time, the reset periods R, the P-phase settling periods PS, and the P-phase AD conversion periods PA of the first pixels of the four-pixel shared cells CEL1 and CEL2 do not overlap the transfer periods K of the first pixels of the four-pixel shared cells CEL1 and CEL2.

In the second readout period PX2, the P-phase pixel signals and the D-phase pixel signals are sequentially read out from the second pixels of the four-pixel shared cells CEL1 and CEL2, and sequentially transmitted through the vertical signal lines VSL1 and VSL2. At this time, the reset periods R, the P-phase settling periods PS, and the P-phase AD conversion periods PA of the second pixels of the four-pixel shared cells CEL1 and CEL2 do not overlap the transfer periods K of the second pixels of the four-pixel shared cells CEL1 and CEL2.

In the third readout period PX3, the P-phase pixel signals and the D-phase pixel signals are sequentially read out from the third pixels of the four-pixel shared cells CEL1 and CEL2, and sequentially transmitted through the vertical signal lines VSL1 and VSL2. At this time, the reset periods R, the P-phase settling periods PS, and the P-phase AD conversion periods PA of the third pixels of the four-pixel shared cells CEL1 and CEL2 do not overlap the transfer periods K of the third pixels of the four-pixel shared cells CEL1 and CEL2.

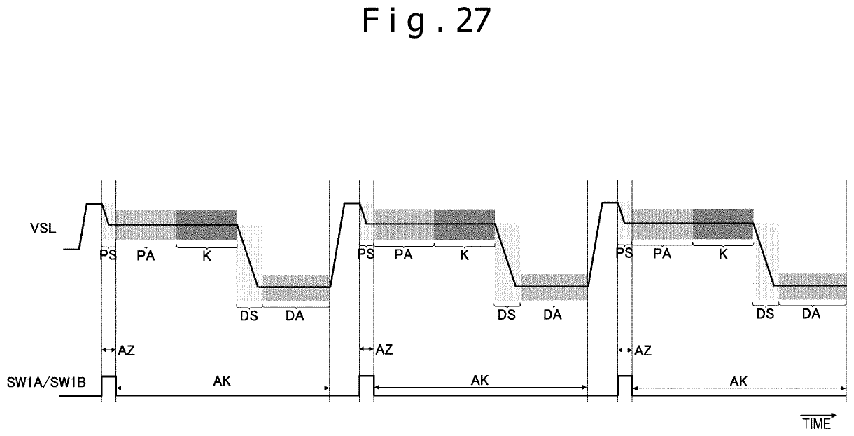

FIG. 27 is a timing chart depicting an operation example of the AD conversion section of one column of the solid-state imaging device according to the eleventh embodiment. Note that the drawing depicts an example of putting AD conversion on standby during the transfer periods of the charge held in the capacitors of the four-pixel shared cells CEL1 to CEL4.

In the processing of putting AD conversion on standby during the transfer periods of the charge held in the capacitors of the four-pixel shared cells CEL1 to CEL4 in the drawing, the comparator CM′ of the fourth embodiment described above is used. At this time, only one of two inputs of the pixel signal of the comparator CM′ is used. At this time, the auto-zero switches SW2A and SW2B and the switches SW12A and SW12B can be turned off at all times.

Then, the auto-zero switches SW1A and SW1B are turned on, setting the auto-zero period AZ1 of the comparator CM′. At this time, the P-phase settling period PS is set during the auto-zero period AZ1.

The current P-phase AD conversion period PA, the transfer period K, the D-phase settling period DS, and the D-phase AD conversion period DA are sequentially set between the current auto-zero period AZ1 and the next auto-zero period AZ1. The comparator CM1 is in use in a period AK from the current P-phase AD conversion period PA to the D-phase AD conversion period DA.

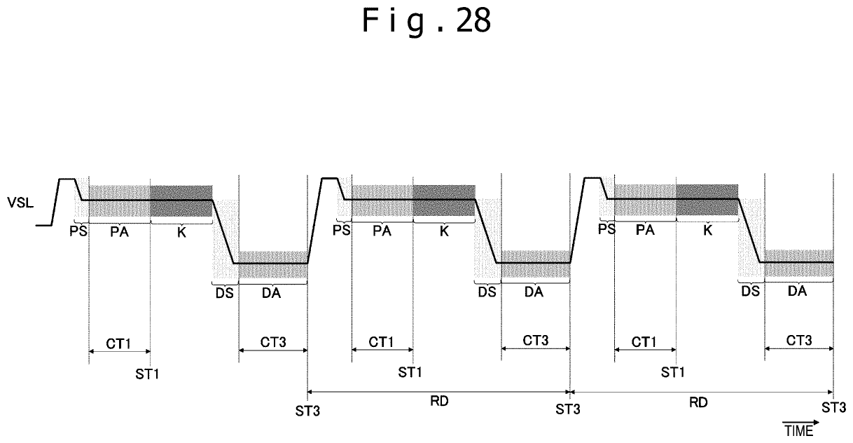

FIG. 28 is a timing chart depicting operation of the CDS processing of the solid-state imaging device according to the eleventh embodiment. Note that the drawing depicts an example of putting AD conversion on standby during the transfer periods of the charge held in the capacitors of the four-pixel shared cells CEL1 to CEL4.

In the processing of putting AD conversion on standby during the transfer periods of the charge held in the capacitors of the four-pixel shared cells CEL1 to CEL4 in the drawing, among the P-phase registers 161 and 162 of the first embodiment described above, only the P-phase register 161 is used and the P-phase register 162 is not used.

At this time, the P-phase count period CT1 is provided in the P-phase AD conversion period PA of each pixel of the four-pixel shared cells CEL1 and CEL2. The D-phase count period CT3 is provided in the D-phase AD conversion period DA of each pixel of the four-pixel shared cells CEL1 and CEL2.

The P-phase count period CT1 of each pixel of the four-pixel shared cells CEL2 and CEL1 is completed, and then the P-phase AD conversion result PN1 is stored in the P-phase register 161 (ST1). The D-phase count period CT3 of each pixel of the four-pixel shared cells CEL1 and CEL2 is completed, and then the CDS calculation is implemented and the CDS processing result CS1 is stored in the output register 164 (ST3). At this time, a readout period RD of each CDS processing result CS1 is set between the storage timings ST3 of each CDS processing result CS1.

Thus, in the eleventh embodiment described above, it is possible to switch the processing that overlaps and the processing that does not overlap the reset periods R, P-phase settling periods PS, and P-phase AD conversion periods PA of the four-pixel shared cells CEL in different rows of the same column with the transfer periods K. This makes it possible to switch between a low power consumption operation and a high frame rate operation in accordance with the imaging environment or the like.

### 12. Twelfth Embodiment

In the sixth embodiment described above, in the four-pixel shared cells to which a charge domain is applied, the pixel signals read out from the pixels in different rows of the same column are time-divisionally AD-converted. In this twelfth embodiment, semiconductor chips provided with a pixel array section in which pixels are arrayed in a matrix are layered.

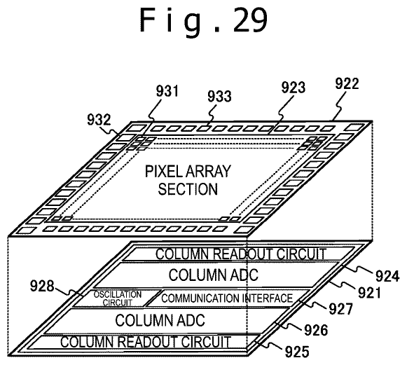

FIG. 29 is a perspective view depicting a layering example of the pixel array section according to the fifth embodiment.

In this drawing, the solid-state imaging device includes semiconductor chips 921 and 922. The semiconductor chip 922 is layered on the semiconductor chip 921.

A pixel array section 923 is formed on the semiconductor chip 922. In the pixel array section 923, pixels 931 are disposed in a matrix in the row direction and the column direction. As the pixels 931, the pixels PIX1 and PIX2 in FIG. 3 may be provided, the four-pixel shared cell CEL in FIG. 18 may be provided, or the two-pixel shared cell CEL in FIG. 22 may be provided. A pad electrode 932 and a via electrode 933 are formed around the pixel array section 923. The via electrode 933 can penetrate the semiconductor chip 922 and electrically connect the semiconductor chips 921 and 922 to each other.

A peripheral circuit 924 is formed in the semiconductor chip 921. The peripheral circuit 924 includes a column readout circuit 925, a column ADC 926, a communication interface 927, and an oscillation circuit 928. The column readout circuit 925 and the column ADC 926 may be formed so as to correspond to positions on both sides of the pixel array section 923 in the column direction. As the column ADC 926, the AD conversion section according to any one of the first to eleventh embodiments described above can be provided.

The semiconductor chips 921 and 922 may be directly bonded to each other. Hybrid bonding can be used for the direct bonding between the semiconductor chips 921 and 922. At this time, the semiconductor chips 921 and 922 may be electrically connected to each other on the basis of Cu—Cu connection. The material of the semiconductor substrate used for the semiconductor chips 921 and 922 may be Si, may be InGaAs, or may be InP.

Thus, in the twelfth embodiment described above, the semiconductor chip 922 on which the pixel array section 923 is formed is layered on the semiconductor chip 921 on which the peripheral circuit 924 is formed. This makes it possible to increase the sensitivity of the solid-state imaging device while suppressing an increase in the mounting area of the semiconductor chips forming the solid-state imaging device.

### 13. Example of Application to Mobile Body

The technology according to the present disclosure (present technology) can be applied to various products. For example, the technology according to the present disclosure may be implemented as a device mounted on any type of mobile bodies such as a vehicle, an electric vehicle, a hybrid electric vehicle, a motorcycle, a bicycle, a personal mobility, an airplane, a drone, a ship, and a robot.

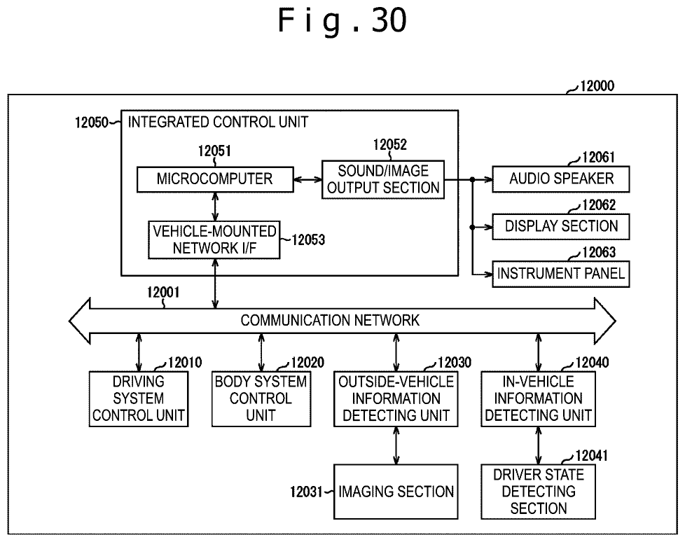

FIG. 30 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 30, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 30, an audio speaker 12061, a display section 12062, and an instrument panel 12063 are illustrated as the output device. The display section 12062 may, for example, include at least one of an on-board display and a head-up display.

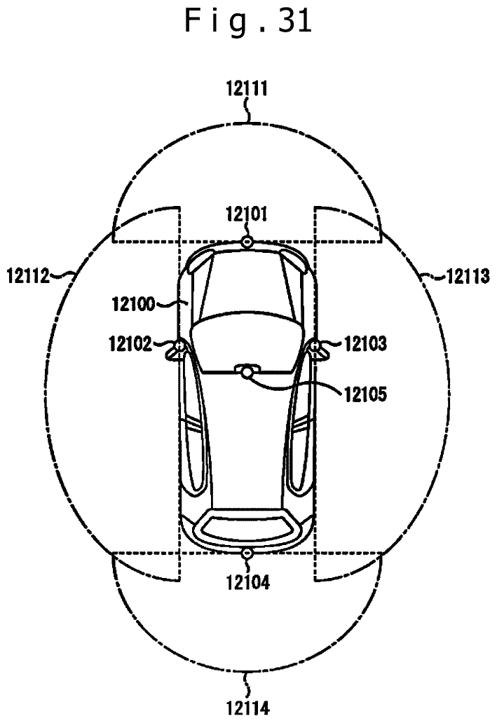

FIG. 31 is a diagram depicting an example of the installation position of the imaging section 12031.

In FIG. 31, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 31 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above. Specifically, for example, the imaging device of the embodiments described above can be applied to the imaging section 12031. By applying the technology according to the present disclosure to the vehicle control system 12000, it is possible to improve the frame rate without changing the configuration of the pixels in a charge domain global shutter system.

Note that the above-described embodiments are examples for embodying the present technology, and the matters according to the embodiments and the matters specifying the invention in the scope of claims have correspondence relationships, respectively. Similarly, the matters specifying the invention in the scope of claims and the matters in the embodiments of the present technology to which the same names are given have correspondence relationships, respectively. However, the present technology is not limited to the embodiments, and can be embodied by applying various modifications to the embodiments without departing from the gist of the present technology. Further, the effects described in the present specification are merely examples and are not limited, and other effects may be provided.

Note that the present technology may also have configurations such as the following.
(1) An imaging device including:
   a pixel configured to transfer and hold charge obtained through photoelectric conversion; and
   an analog-to-digital (AD) conversion section configured to time-divisionally switch AD conversion of pixel signals read out from a plurality of the pixels in different rows of the same column.
(2) The imaging device according to (1),
   wherein the pixel includes
   a photoelectric conversion section,
   a capacitor configured to hold charge obtained through photoelectric conversion by the photoelectric conversion section,
   a first transfer transistor configured to transfer, to the capacitor, the charge obtained through photoelectric conversion by the photoelectric conversion section,
   a second transfer transistor configured to transfer, to a floating diffusion, the charge held in the capacitor,
   an output transistor configured to output the pixel signal on the basis of the charge transferred to the floating diffusion, and
   a selection transistor configured to select an output of the pixel signal.
(3) The imaging device according to (2),
   wherein the AD conversion section is configured to implement, in an AD conversion period overlapping a transfer period of transferring the charge held in the capacitor of a first pixel of a first row in a first column to the floating diffusion, AD conversion of the pixel signal read out from a second pixel of a second row in the first column.
(4) The imaging device according to (3), including:
   a vertical signal line configured to transmit the pixel signal in a column direction;
   a first comparator with an input connected to the vertical signal line; and
   a second comparator with an input connected to the vertical signal line.
(5) The imaging device according to (4),
   wherein, after an auto-zero operation of the first comparator, P-phase AD conversion of the pixel signal read out from the first pixel is implemented by the first comparator,
   after the implementation of the P-phase AD conversion of the pixel signal read out from the first pixel, an auto-zero operation of the second comparator is implemented,
   after the implementation of the auto-zero operation of the second comparator, P-phase AD conversion of the pixel signal read out from the second pixel is implemented by the second comparator,
   after the implementation of the P-phase AD conversion of the pixel signal read out from the second pixel, D-phase AD conversion of the pixel signal read out from the first pixel is implemented by the first comparator, and
   after the implementation of the D-phase AD conversion of the pixel signal read out from the first pixel, D-phase AD conversion of the pixel signal read out from the second pixel is implemented by the second comparator.
(6) The imaging device according to (5),
   wherein the AD conversion by the second comparator is put on standby during the AD conversion by the first comparator, and
   the AD conversion by the first comparator is put on standby during the AD conversion by the second comparator.
(7) The imaging device according to (3), including:
   a vertical signal line configured to transmit the pixel signal in a column direction;
   a comparator with an input connected to the vertical signal line;
   a first switch connected between the input of the comparator and the vertical signal line; and
   a second switch connected between the input of the comparator and the vertical signal line.
(8) The imaging device according to (7),
   wherein AD conversion of the pixel signal read out from the first pixel is implemented when the first switch is on and the second switch is off, and
   AD conversion of the pixel signal read out from the second pixel is implemented by the comparator when the first switch is off and the second switch is on.
(9) The imaging device according to (3), including:
   a vertical signal line configured to transmit the pixel signal in a column direction; and
   a comparator with a first input and a second input connected to the vertical signal line,
   wherein the comparator includes
   a first transistor,
   a second transistor,
   a third transistor configured to form a differential pair with each of the first transistor and the second transistor,
   a fourth transistor configured to form a differential pair with each of the first transistor and the second transistor,
   a first switch connected in series to the first transistor,
   a second switch connected in series to the second transistor,
   a third switch connected in series to the third transistor, and
   a fourth switch connected in series to the fourth transistor.
(10) The imaging device according to (9), including:
   a first capacitor connected in series to a gate of the first transistor;
   a second capacitor connected in series to a gate of the second transistor;
   a third capacitor connected in series to a gate of the third transistor;
   a fourth capacitor connected in series to a gate of the fourth transistor;
   a first auto-zero switch connected between the gate of the first transistor and the first switch;
   a second auto-zero switch connected between the gate of the second transistor and the second switch;
   a third auto-zero switch connected between the gate and a drain of the third transistor; and
   a fourth auto-zero switch connected between the gate and a drain of the fourth transistor.
(11) The imaging device according to (10),
   when the first switch and the third switch are on and the second switch and the fourth switch are off, the first auto-zero switch and the third auto-zero switch turn on to implement an auto-zero operation, and then P-phase AD conversion of the pixel signal read out from the first pixel is implemented by the comparator,
   when the first switch and the third switch are off and the second switch and the fourth switch are on, the second auto-zero switch and the fourth auto-zero switch turn on to implement an auto-zero operation, and then P-phase AD conversion of the pixel signal read out from the second pixel is implemented by the comparator,
   when the first switch and the third switch are on and the second switch and the fourth switch are off, D-phase AD conversion of the pixel signal read out from the first pixel is implemented by the comparator, and
   when the first switch and the third switch are off and the second switch and the fourth switch are on, D-phase AD conversion of the pixel signal read out from the second pixel is implemented by the comparator.
(12) The imaging device according to any one of (3) to (11), further including:
   a first P-phase register configured to hold a P-phase AD conversion result of the pixel signal read out from the first pixel;
   a second P-phase register configured to hold a P-phase AD conversion result of the pixel signal read out from the second pixel; and
   a correlated double sampling (CDS) processing unit configured to implement
   first CDS processing on the basis of the P-phase AD conversion result of the pixel signal read out from the first pixel and held in the first P-phase register and a D-phase AD conversion result of the pixel signal read out from the first pixel and output from the AD conversion section, and
   second CDS processing on the basis of the P-phase AD conversion result of the pixel signal read out from the second pixel and held in the second P-phase register and a D-phase AD conversion result of the pixel signal read out from the second pixel and output from the AD conversion section.
(13) The imaging device according to any one of (1) to (12),
   wherein the pixel is configured to transfer and hold the charge obtained by photoelectric conversion on the basis of a global shutter operation.
(14) A comparator including:
   a first transistor;
   a second transistor;
   a third transistor configured to form a differential pair with each of the first transistor and the second transistor;
   a fourth transistor configured to form a differential pair with each of the first transistor and the second transistor;
   a first switch connected in series to the first transistor;
   a second switch connected in series to the second transistor;
   a third switch connected in series to the third transistor; and
   a fourth switch connected in series to the fourth transistor.
(15) The comparator according to (14),
   wherein a first capacitor is connected in series to a gate of the first transistor,
   a second capacitor is connected in series to a gate of the second transistor,
   a third capacitor is connected in series to a gate of the third transistor,
   a fourth capacitor is connected in series to a gate of the fourth transistor,
   a first auto-zero switch is connected between the gate of the first transistor and the first switch,
   a second auto-zero switch is connected between the gate of the second transistor and the second switch,
   a third auto-zero switch is connected between the gate and a drain of the third transistor, and
   a fourth auto-zero switch is connected between the gate and a drain of the fourth transistor.
(16) The comparator according to (15),
   wherein the second switch and the fourth switch are turned off when the first switch and the third switch are turned on, and
   the second switch and the fourth switch are turned on when the first switch and the third switch are turned off.
(17) The comparator according to (16),
   wherein the first auto-zero switch and the third auto-zero switch are turned on when the first switch and the third switch are turned on, and
   the second auto-zero switch and the fourth auto-zero switch are turned on when the second switch and the fourth switch are turned on.
(18) The comparator according to any one of (14) to (17),
   wherein a gate of the first transistor and a gate of the second transistor are connected to the same signal line, and
   a gate of the third transistor and a gate of the fourth transistor receive the same reference signal.
(19) An imaging method including:
   transferring, by a first pixel of a first row in a first column, charge obtained through photoelectric conversion to, and holding the charge in, a capacitor in the first pixel;
   transferring, by a second pixel of a second row in the first column, charge obtained through photoelectric conversion to, and holding the charge in, a capacitor in the second pixel; and
   implementing, by an AD conversion section, AD conversion of a pixel signal read out from the second pixel in an AD conversion period overlapping a transfer period of transferring the charge held in the capacitor of the first pixel to a floating diffusion.

### REFERENCE SIGNS LIST

100 Imaging device
101 Optical system
102 Solid-state imaging device
103 Imaging control unit
104 Image processing unit
105 Storage section
106 Display section
107 Operation section
108 Bus
111 Pixel array section
112 Vertical scanning circuit
113 Column readout circuit
114 Column signal processing unit
115 Horizontal scanning circuit
116 Control circuit
PIX1, PIX2 Pixel
HSL Horizontal drive line
VSL Vertical signal line
PD1, PD2 Photodiode
FD1, FD2 Floating diffusion
CA1, CA2 Capacitor
122, 222 Overflow control transistor
123, 124, 223, 224 Transfer transistor
125, 225 Reset transistor
126, 226 Output transistor
127, 227 Selection transistor
131-1 to 131-3 Comparison section
132-1 to 132-3 Counter

1. An imaging device comprising:
a pixel configured to transfer and hold charge obtained through photoelectric conversion; and
an analog-to-digital (AD) conversion section configured to time-divisionally switch AD conversion of pixel signals read out from a plurality of the pixels in different rows of the same column.

2. The imaging device according to claim 1,
wherein the pixel includes
a photoelectric conversion section,
a capacitor configured to hold charge obtained through photoelectric conversion by the photoelectric conversion section,
a first transfer transistor configured to transfer, to the capacitor, the charge obtained through photoelectric conversion by the photoelectric conversion section,
a second transfer transistor configured to transfer, to a floating diffusion, the charge held in the capacitor,
an output transistor configured to output the pixel signal on the basis of the charge transferred to the floating diffusion, and
a selection transistor configured to select an output of the pixel signal.

3. The imaging device according to claim 2,
wherein the AD conversion section is configured to implement, in an AD conversion period overlapping a transfer period of transferring the charge held in the capacitor of a first pixel of a first row in a first column to the floating diffusion, AD conversion of the pixel signal read out from a second pixel of a second row in the first column.

4. The imaging device according to claim 3, comprising:
a vertical signal line configured to transmit the pixel signal in a column direction;
a first comparator with an input connected to the vertical signal line; and
a second comparator with an input connected to the vertical signal line.

5. The imaging device according to claim 4,
wherein, after an auto-zero operation of the first comparator, P-phase AD conversion of the pixel signal read out from the first pixel is implemented by the first comparator,
after the implementation of the P-phase AD conversion of the pixel signal read out from the first pixel, an auto-zero operation of the second comparator is implemented,
after the implementation of the auto-zero operation of the second comparator, P-phase AD conversion of the pixel signal read out from the second pixel is implemented by the second comparator,
after the implementation of the P-phase AD conversion of the pixel signal read out from the second pixel, D-phase AD conversion of the pixel signal read out from the first pixel is implemented by the first comparator, and
after the implementation of the D-phase AD conversion of the pixel signal read out from the first pixel, D-phase AD conversion of the pixel signal read out from the second pixel is implemented by the second comparator.

6. The imaging device according to claim 5,
wherein the AD conversion by the second comparator is put on standby during the AD conversion by the first comparator, and
the AD conversion by the first comparator is put on standby during the AD conversion by the second comparator.

7. The imaging device according to claim 3, comprising:
a vertical signal line configured to transmit the pixel signal in a column direction;
a comparator with an input connected to the vertical signal line;
a first switch connected between the input of the comparator and the vertical signal line; and
a second switch connected between the input of the comparator and the vertical signal line.

8. The imaging device according to claim 7,
wherein AD conversion of the pixel signal read out from the first pixel is implemented when the first switch is on and the second switch is off, and
AD conversion of the pixel signal read out from the second pixel is implemented by the comparator when the first switch is off and the second switch is on.

9. The imaging device according to claim 3, comprising:
a vertical signal line configured to transmit the pixel signal in a column direction; and
a comparator with a first input and a second input connected to the vertical signal line,
wherein the comparator includes
a first transistor,
a second transistor,
a third transistor configured to form a differential pair with each of the first transistor and the second transistor,
a fourth transistor configured to form a differential pair with each of the first transistor and the second transistor,
a first switch connected in series to the first transistor,
a second switch connected in series to the second transistor,
a third switch connected in series to the third transistor, and
a fourth switch connected in series to the fourth transistor.

10. The imaging device according to claim 9, comprising:
a first capacitor connected in series to a gate of the first transistor;
a second capacitor connected in series to a gate of the second transistor;
a third capacitor connected in series to a gate of the third transistor;
a fourth capacitor connected in series to a gate of the fourth transistor;
a first auto-zero switch connected between the gate of the first transistor and the first switch;
a second auto-zero switch connected between the gate of the second transistor and the second switch;
a third auto-zero switch connected between the gate and a drain of the third transistor; and
a fourth auto-zero switch connected between the gate and a drain of the fourth transistor.

11. The imaging device according to claim 10,
when the first switch and the third switch are on and the second switch and the fourth switch are off, the first auto-zero switch and the third auto-zero switch turn on to implement an auto-zero operation, and then P-phase AD conversion of the pixel signal read out from the first pixel is implemented by the comparator,
when the first switch and the third switch are off and the second switch and the fourth switch are on, the second auto-zero switch and the fourth auto-zero switch turn on to implement an auto-zero operation, and then P-phase AD conversion of the pixel signal read out from the second pixel is implemented by the comparator,
when the first switch and the third switch are on and the second switch and the fourth switch are off, D-phase AD conversion of the pixel signal read out from the first pixel is implemented by the comparator, and
when the first switch and the third switch are off and the second switch and the fourth switch are on, D-phase AD conversion of the pixel signal read out from the second pixel is implemented by the comparator.

12. The imaging device according to claim 3, further comprising:
a first P-phase register configured to hold a P-phase AD conversion result of the pixel signal read out from the first pixel;
a second P-phase register configured to hold a P-phase AD conversion result of the pixel signal read out from the second pixel; and
a correlated double sampling (CDS) processing unit configured to implement
first CDS processing on the basis of the P-phase AD conversion result of the pixel signal read out from the first pixel and held in the first P-phase register and a D-phase AD conversion result of the pixel signal read out from the first pixel and output from the AD conversion section, and
second CDS processing on the basis of the P-phase AD conversion result of the pixel signal read out from the second pixel and held in the second P-phase register and a D-phase AD conversion result of the pixel signal read out from the second pixel and output from the AD conversion section.

13. The imaging device according to claim 1,
wherein the pixel is configured to transfer and hold the charge obtained by photoelectric conversion on the basis of a global shutter operation.

14. A comparator comprising:
a first transistor;
a second transistor;
a third transistor configured to form a differential pair with each of the first transistor and the second transistor;
a fourth transistor configured to form a differential pair with each of the first transistor and the second transistor;
a first switch connected in series to the first transistor;
a second switch connected in series to the second transistor;
a third switch connected in series to the third transistor; and
a fourth switch connected in series to the fourth transistor.

15. The comparator according to claim 14,
wherein a first capacitor is connected in series to a gate of the first transistor,
a second capacitor is connected in series to a gate of the second transistor,
a third capacitor is connected in series to a gate of the third transistor,
a fourth capacitor is connected in series to a gate of the fourth transistor,
a first auto-zero switch is connected between the gate of the first transistor and the first switch,
a second auto-zero switch is connected between the gate of the second transistor and the second switch,
a third auto-zero switch is connected between the gate and a drain of the third transistor, and
a fourth auto-zero switch is connected between the gate and a drain of the fourth transistor.

16. The comparator according to claim 15,
wherein the second switch and the fourth switch are turned off when the first switch and the third switch are turned on, and
the second switch and the fourth switch are turned on when the first switch and the third switch are turned off.

17. The comparator according to claim 16,
wherein the first auto-zero switch and the third auto-zero switch are turned on when the first switch and the third switch are turned on, and
the second auto-zero switch and the fourth auto-zero switch are turned on when the second switch and the fourth switch are turned on.

18. The comparator according to claim 14,
wherein a gate of the first transistor and a gate of the second transistor are connected to the same signal line, and
a gate of the third transistor and a gate of the fourth transistor receive the same reference signal.

19. An imaging method comprising:
transferring, by a first pixel of a first row in a first column, charge obtained through photoelectric conversion to, and holding the charge in, a capacitor in the first pixel;
transferring, by a second pixel of a second row in the first column, charge obtained through photoelectric conversion to, and holding the charge in, a capacitor in the second pixel; and
implementing, by an AD conversion section, AD conversion of a pixel signal read out from the second pixel in an AD conversion period overlapping a transfer period of transferring the charge held in the capacitor of the first pixel to a floating diffusion.
